(19) United States
(12) Patent Application Publication
(10) Pub. No.: US 2006/0146934 A1
(43) Pub. Date: Jul. 6, 2006

(54) Video coding

(76) Inventors: Kerem Caglar, Tampere (FI); Miska Hannuksela, Tampere (FI)

Correspondence Address: HARRINGTON & SMITH, LLP, 4 RESEARCH DRIVE, SHELTON, CT, 06484-6212, US

(21) Appl. No.: 11/369,321

(22) Filed: Mar. 6, 2006

Related U.S. Application Data
(62) Division of application No. 09/935,119, filed on Aug. 21, 2001.

(30) Foreign Application Priority Data
Aug. 21, 2000 (FI) FI 20001847

(51) Int. Cl. H04N 7/12; H04N 11/04; H04B 1/66; H04N 11/02

(52) U.S. Cl. 375/240.12

(57) ABSTRACT

A method for encoding a video signal comprises the steps of:

encoding a first complete frame by forming a bit-stream containing information for its subsequent full reconstruction (150) the information being prioritised (148) into high and low priority information;

defining (160) at least one virtual frame on the basis of a version of the first complete frame constructed using the high priority information of the first complete frame in the absence of at least some of the low priority information of the first complete frame; and

encoding (146) a second complete frame by forming a bit-stream containing information for its subsequent full reconstruction the information being prioritised into high and low priority information enabling the second complete frame to be fully reconstructed on the basis of the virtual frame rather than on the basis of the first complete frame. A corresponding decoding method is also described.

### FIELD OF THE INVENTION

The invention relates to data transmission and is particularly, but not exclusively, related to transmission of data representative of picture sequences, such as video. It is particularly suited to transmission over links susceptible to errors and loss of data, such as over the air interface of a cellular telecommunications system.

### BACKGROUND OF THE INVENTION

During the past few years, the amount of multi-media content available through the Internet has increased considerably. Since data delivery rates to mobile terminals are becoming high enough to enable such terminals to retrieve multi-media content, it is becoming desirable to provide such retrieval from the Internet. An example of a high-speed data delivery system is the General Packet Radio Service (GPRS) of the planned GSM phase 2+.

The term multi-media as used herein includes both sound and pictures, sound only and pictures only. Sound includes speech and music.

In the Internet, transmission of multi-media content is packet-based. Network traffic through the Internet is based on a transport protocol called the Internet Protocol (IP). IP is concerned with transporting data packets from one location to another. It facilitates the routing of packets through intermediate gateways, that is, it allows data to be sent to machines (e.g. routers) that are not directly connected in the same physical network. The unit of data transported by the IP layer is called an IP datagram. The delivery service offered by IP is connectionless, that is IP datagrams are routed around the Internet independently of each other. Since no resources are permanently committed within the gateways to any particular connection, the gateways may occasionally have to discard datagrams because of lack of buffer space or other resources. Thus, the delivery service offered by IP is a best effort service rather than a guaranteed service.

Internet multi-media is typically streamed using the User Datagram Protocol (UDP), the Transmission Control Protocol (TCP) or the Hypertext Transfer Protocol (HTTP). UDP does not check that the datagrams have been received, does not retransmit missing datagrams, nor does it guarantee that the datagrams are received in the same order as they were transmitted. UDP is connectionless. TCP checks that the datagrams have been received and retransmits missing datagrams. It also guarantees that the datagrams are received in the same order as they were transmitted. TCP is connection orientated.

In order to ensure multi-media content of a sufficient quality is delivered, it can be provided over a reliable network connection, such as TCP, to ensure that received data are error-free and in the correct order. Lost or corrupted protocol data units are retransmitted.

Sometimes re-transmission of lost data is not handled by the transport protocol but rather by some higher-level protocol. Such a protocol can select the most vital lost parts of a multi-media stream and request the re-transmission of those. The most vital parts can be used for prediction of other parts of the stream, for example.

Multi-media content typically includes video. In order to be transmitted efficiently, video is often compressed. Therefore, compression efficiency is an important parameter in video transmission systems. Another important parameter is tolerance to transmission errors. Improvement in either one of these parameters tends to adversely affect the other and so a video transmission system should have a suitable balance between the two.

FIG. 1 shows a video transmission system. The system comprises a source coder which compresses an uncompressed video signal to a desired bit rate thereby producing an encoded and compressed video signal and a source decoder which decodes the encoded and compressed video signal to reconstruct the uncompressed video signal. The source coder comprises a waveform coder and an entropy coder. The waveform coder performs lossy video signal compression and the entropy coder losslessly converts the output of the waveform coder into a binary sequence. The binary sequence is conveyed from the source coder to a transport coder which encapsulates the compressed video according to a suitable transport protocol and then transmits it to a receiver comprising a transport decoder and a source decoder. The data is transmitted by the transport coder to the transport decoder over a transmission channel. The transport coder may also manipulate the compressed video in other ways. For example, it may interleave and modulate the data. After being received by the transport decoder the data is then passed on to the source decoder. The source decoder comprises a waveform decoder and an entropy decoder. The transport decoder and the source, decoder perform inverse operations to obtain a reconstructed video signal for display. The receiver may also provide feedback to the transmitter. For example, the receiver may signal the rate of successfully received transmission data units.

A video sequence consists of a series of still images. A video sequence is compressed by reducing its redundant and perceptually irrelevant parts. The redundancy in a video sequence, can be categorised as spatial, temporal and spectral redundancy. Spatial redundancy refers to the correlation between neighbouring pixels within the same image. Temporal redundancy refers to the fact that objects appearing in a previous image are likely to appear in a current image. Spectral redundancy refers to the correlation between the different colour components of an image.

Temporal redundancy can be reduced by generating motion compensation data, which describes relative motion between the current image and a previous image (referred to as a reference or anchor picture). Effectively the current image is formed as a prediction from a previous one and the technique by which this is achieved is commonly referred to as motion compensated prediction or motion compensation. In addition to predicting one picture from another, parts or areas of a single picture may be predicted from other parts or areas of that picture.

A sufficient level of compression cannot usually be reached just by reducing the redundancy of a video sequence. Therefore, video encoders also try to reduce the quality of those parts of the video sequence which are subjectively less important. In addition, the redundancy of the encoded bit-stream is reduced by means of efficient lossless coding of compression parameters and coefficients. The main technique is to use variable length codes.

Video compression methods typically differentiate images on the basis of whether they do or do not utilise temporal redundancy reduction (that is, whether they are predicted or not). Referring to FIG. 2, compressed images which do not utilise temporal redundancy reduction methods are usually called INTRA or I-frames. INTRA frames are frequently introduced to prevent the effects of packet losses from propagating spatially and temporally. In broadcast situations, INTRA frames enable new receivers to start decoding the stream, that is they provide “access points”. Video coding systems typically enable insertion of INTRA frames periodically every n seconds or n frames. It is also advantageous to utilise INTRA frames at natural scene cuts where the image content changes so much that temporal prediction from the previous image is unlikely to be successful or desirable in terms of compression efficiency.

Compressed images which do utilise temporal redundancy reduction methods are usually called INTER or P-frames. INTER frames employing motion-compensation are rarely precise enough to allow sufficiently accurate image reconstruction and so a spatially compressed prediction error image is also associated with each INTER frame. This represents the difference between the current frame and its prediction.

Many video compression schemes also introduce temporally bi-directionally-predicted frames, which are commonly referred to as B-pictures or B-frames. B-frames are inserted between anchor (I or P). frame pairs and are predicted from either one or both of the anchor frames, as shown in FIG. 2. B-frames are not themselves used as anchor frames, that is other frames are never predicted from them and are simply used to enhance perceived image quality by increasing the picture display rate. As they are never used themselves as anchor frames, they can be dropped without affecting, the decoding of subsequent frames. This enables a video sequence to be decoded at different rates according to bandwidth constraints of the transmission network, or different decoder capabilities.

The term group of pictures (GOP) is used to describe an INTRA frame followed by a sequence of temporally predicted (P or B) pictures predicted from it.

Various international video coding standards have been developed. Generally, these standards define the bit-stream syntax used to represent a compressed video sequence and the way in which the bit-stream is decoded. One such standard, H.263, is a recommendation developed by the International Telecommunications Union (ITU). Currently, there are two versions of H.263. Version 1 consists of a core algorithm and four optional coding modes. H.263 version 2 is an extension of version 1 which provides twelve negotiable coding modes. H.263 version 3, which is presently under development, is intended to contain two new coding modes and a set of additional supplemental enhancement information code-points.

According to H.263, pictures are coded as a luminance component (Y) and two colour difference (chrominance), components (C_{B} and C_{R}). The chrominance components are sampled at half spatial resolution along both co-ordinate axes compared to the luminance component. The luminance data and spatially sub-sampled chrominance data is assembled into mabroblocks (MBs). Typically a macroblock comprises 16×16 pixels of luminance data and the spatially corresponding 8×8 pixels of chrominance data.

Each coded picture, as well as the corresponding coded bit-stream, is arranged in a hierarchical structure with four layers which are, from top to bottom, a picture layer, a picture segment layer, a macroblock (MB) layer and a block layer. The picture segment layer can be either a group of blocks layer or a slice layer.

The picture layer data contains parameters affecting the whole picture area and the decoding of the picture data. The picture layer data is arranged in a so-called picture header.

By default, each picture is divided into groups of blocks. A group of blocks (GOB) typically comprises 16 sequential pixel lines. Data for each GOB comprises an optional GOB header followed by data for macroblocks.

If an optional slice structured mode is used, each picture is divided into slices instead of GOBs. Data for each slice comprises a slice header followed by data for macroblocks.

A slice defines a region within a-coded picture. Typically, the region is a number of macroblocks in normal scanning order. There are no prediction dependencies across slice boundaries within the same coded picture. However, temporal prediction can generally cross slice boundaries unless H.263 Annex R (Independent Segment Decoding) is used. Slices can be decoded independently from the rest of the image data (except for the picture header). Consequently, the use of slice structured mode improves error resilience in packet-based networks that are prone to packet loss, so-called packet-lossy networks.

Picture, GOB and slice headers begin with a synchronisation code. No other code word or valid combination of code words can form the same bit pattern as the synchronisation codes. Thus, the synchronisation codes can be used for bit-stream error detection and re-synchronisation after bit errors. The more synchronisation codes that are added to the bit-stream the more error-robust coding becomes.

Each GOB or slice is divided into macroblocks. As explained above, a macroblock comprises 16×16 pixels of luminance data and the spatially corresponding 8×8 pixels of chrominance data. In other words, an MB comprises four 8×8 blocks of luminance data and the two spatially corresponding 8×8 blocks of chrominance data.

A block comprises 8×8 pixels of luminance or chrominance data. Block layer data consists of uniformly quantised discrete cosine transform coefficients, which are scanned in zig-zag order, processed with a run-length encoder and coded with variable length codes, as explained in detail in ITU-T recommendation H.263.

One useful property of coded bit-streams is scalability. In the following, bit-rate scalability is described. The term bit-rate scalability refers to the ability of a compressed sequence to be decoded at different data rates. A compressed sequence encoded so as to have bit-rate scalability can be streamed over channels with different bandwidths and can be decoded and-played back in real-time at different receiving terminals.

Scalable multi-media is typically-ordered into hierarchical layers of data. A base layer contains an individual representation of a multi-media data, such as a video sequence and enhancement layers contain refinement data which can be used in addition to the base layer. The quality of the multi-media clip improves progressively as enhancement layers are added to the base layer. Scalability may take many different forms including, but not limited to temporal, signal-to-noise-ratio (SNR) and spatial scalability, all of which are described in further detail below.

Scalability is a desirable property for heterogeneous and error prone environments such as the Internet and wireless channels in cellular communications networks. This property is desirable in order to counter limitations such as constraints on bit rate, display resolution, network throughput and decoder complexity.

In multi-point and broadcast multi-media applications, constraints on network throughput may not be foreseen at the time of encoding. Thus, it is advantageous to encode multi-media content to form a scalable bit-stream. An example of a scalable bit-stream being used in IP multi-casting is shown in FIG. 3. Each routeer (R1-R3) can strip the bit-stream according to its capabilities. In this example, the server S has a multi-media clip which can be scaled to at least three bit rates, 120 kbit/s, 60 kbit/s and 28 kbit/s. In the case of a multi-cast transmission, where the same bit-stream is delivered to multiple clients at the same time with as few copies of the bit-stream being generated in the network as possible, it is beneficial from the point of view of network bandwidth to transmit a single, bit-rate-scalable bit-stream.

If a sequence is downloaded and played back in different devices each having different processing powers, bit rate scalability can be used in devices having lower processing power to provide a lower quality representation of the video sequence by decoding only a part of of the bit-stream. Devices having higher processing power can decode and play the sequence with full quality. Additionally, bit-rate scalability means that the processing power needed for decoding a lower quality representation of the video sequence is lower than when decoding the full quality sequence. This can be viewed as a form of computational scalability.

If a video sequence is pre-stored in a streaming server, and the server has to temporarily reduce the bit-rate at which it is being transmitted as a bit-stream, for example in order to avoid congestion in the network, it is advantageous if the server can reduce the bit-rate of the bit-stream whilst still transmitting a useable bit-stream. This is typically achieved using bit-rate scalable coding.

Scalability can also be used to improve error resilience in a transport system where layered coding is combined with transport prioritisation. The term transport prioritisation is used to describe mechanisms that provide different qualities of service in transport. These include unequal error protection, which provides different channel error/loss rates, and assigning different priorities to support different delay/loss requirements. For example, the base layer of a scalably encoded bit-stream may be delivered through a transmission channel with a high degree of error protection, whereas the enhancement layers may be transmitted in more error-prone channels.

One problem with scalable multi-media coding is that it often suffers from a worse compression efficiency than non-scalable coding. A high-quality scalable video sequence generally requires more bandwidth than a non-scalable, single-layer video sequence of a corresponding quality. However, exceptions to this general rule do exist. For example, because B-frames can be dropped from a compressed video sequence without adversely affecting the quality of subsequently coded pictures, they can be regarded as providing a form of temporal scalability. In other words, the bit-rate of a video sequence compressed to form a sequence of temporal predicted pictures including e.g. alternating P and B-frames can be reduced by removing the B-frames. This has the effect of reducing the frame-rate of the compressed sequence. Hence the term temporal scalability. In many cases, the use of B-frames may actually improve coding efficiency, especially at high frame rates and thus a compressed video sequence comprising B-frames in addition to P-frames may exhibit a higher compression efficiency than a sequence having equivalent quality encoded using only P-frames. However, the improvement in compression performance provided by B-frames is achieved at the expense of increased computational complexity and memory requirements. Additional delays are also introduced.

Signal-to-Noise Ratio (SNR) scalability is illustrated in FIG. 4. SNR scalability involves the creation of a multi-rate-bit-stream. It allows for the recovery of coding errors, or differences, between an original picture and its reconstruction. This is achieved by using a finer quantiser to encode a difference picture in an enhancement layer. This additional information increases the SNR of the overall reproduced picture.

Spatial scalability allows for the creation of multi-resolution bit-streams to meet varying display requirements/constraints. A spatially scalable structure is shown in FIG. 5. It is similar to that used in SNR scalability. In spatial scalability, a spatial enhancement layer is used to recover the coding loss between an up-sampled version of the reconstructed layer used as a reference by the enhancement layer, that is the reference layer, and a higher resolution version of the original picture. For example, if the reference layer has a Quarter Common Intermediate Format (QCIF) resolution, 176×144 pixels, and the enhancement layer has a Common Intermediate Format (CIF) resolution, 352×288 pixels, the reference layer picture must be scaled accordingly such that the enhancement layer picture can be appropriately predicted from it. According to H.263 the resolution is increased by a factor of two in the vertical direction only, horizontal direction only, or both the vertical and horizontal directions for a single enhancement layer. There can be multiple enhancement layers, each increasing picture resolution over that of the previous layer. Interpolation filters used to up-sample the reference layer picture are explicitly defined in H.263. Apart from the up-sampling process from the reference to the enhancement layer, the processing and syntax of a spatially scaled picture are identical to those of an SNR scaled picture. Spatial scalability provides increased spatial resolution over SNR scalability.

In either SNR or spatial scalability, the enhancement layer pictures are referred to s EI- or EP-pictures. If the enhancement layer picture is upwardly predicted from an INTRA picture in the reference layer, then the enhancement layer picture is referred to as an Enhancement-I (EI) picture. In some cases, when reference layer pictures are poorly predicted, over-coding of static parts of the picture can occur in the enhancement layer, requiring an excessive bit rate. To avoid this problem, forward prediction is permitted in the enhancement layer. A picture that is forwardly predicted from a previous enhancement layer picture or upwardly predicted from a predicted picture in the reference layer is referred to as an Enhancement-P (EP) picture. Computing the average of both upwardly and forwardly predicted pictures can provide a bidirectional prediction option for EP-pictures. Upward prediction of EI- and EP-pictures from a reference layer picture implies that no motion vectors are required. In the case of forward prediction for EP-pictures, motion vectors are required.

The scalability mode (Annex O) of H.263 specifies syntax to support temporal, SNR, and spatial scalability capabilities.

One problem with conventional SNR scalability coding is termed drifting. Drifting refers to the impact of a transmission error. A visual artefact caused by an error drifts temporally from the picture in which the error occurs. Due to the use of motion compensation, the area of the visual artefact may increase from picture to picture. In the case of scalable coding, the visual artefact also drifts from lower enhancement layers to higher layers. The effect of drifting can be explained with reference to FIG. 7 which shows conventional prediction relationships used in scalable coding. Once an error or packet loss has occurred in an enhancement layer, it propagates to the end of a group of pictures (GOP), since the pictures are predicted from each other in sequence. In addition, since the enhancement layers are based on the base layer, an error in the base layer causes errors in the enhancement layers. Because prediction also occurs between the enhancement layers, a serious drifting problem can occur in the higher layers of subsequent predicted frames. Even though there may subsequently be sufficient bandwidth to send data to correct an error, the decoder is not able to eliminate the error until the prediction chain is re-initialised by another INTRA picture representing the start of a new GOP.

To deal with this problem, a form of scalability referred to as Fine Granularity Scalability (FGS) has been developed. In FGS a low-quality base layer is coded using a hybrid predictive loop and an, (additional) enhancement layer delivers the progressively encoded residue between the reconstructed base layer and the original frame. FGS has been proposed, for example, in MPEG-4 visual standardisation.

An example of prediction relationships in fine granularity scalable coding is shown in FIG. 6. In a fine granularity scalable video coding scheme, the base-layer video is transmitted in a well-controlled channel (e.g. one with a high degree of error protection) to minimise error or packet-loss, in such a way that the base layer is encoded to fit into the minimum channel bandwidth. This minimum is the lowest bandwidth that may occur or may be encountered during operation. All enhancement layers in the prediction frames are coded based on the base layer in the reference frames. Thus, errors in the enhancement layer of one frame do not cause a drifting problem in the enhancement layers of subsequently predicted frames and the coding scheme can adapt to channel conditions. However, since prediction is always based on a low quality base-layer, the coding efficiency of FGS coding is not as good as, and is sometimes much worse than, conventional SNR scalability schemes such as, those provided for in H.263 Annex O.

In order to combine the advantages of both FGS coding and conventional layered scalability coding, a hybrid coding scheme shown in FIG. 8 has been, proposed which is called Progressive FGS (PFGS). There are two points to note. Firstly, in PFGS as many predictions as possible from the same layer are used to maintain coding efficiency. Secondly, a prediction path always uses prediction from a lower layer in the reference frame to enable error recovery and channel adaptation. The first point makes sure that, for a given video layer, motion prediction is as accurate as possible, thus maintaining coding efficiency. The second point makes, sure that drifting is reduced in the case of channel congestion, packet loss or packet error. Using this coding structure, there is no need to re-transmit lost/erroneous packets in the enhancement layer data since the enhancement layers can be gradually and automatically reconstructed over a period of a few frames.

In FIG. 8, frame 2 is predicted from the even layers of frame 1 (that is the base layer and the 2nd layer). Frame 3 is predicted from the odd layers of frame 2 (that is the 1st and the 3rd layer). in turn, frame 4 is predicted from the even layers of frame 3. This odd/even prediction pattern continues. The term group depth is used to describe the number of layers that refer back to a common reference layer.

FIG. 8 exemplifies a case where the group depth is 2. The group depth can be changed. If the depth is 1, the situation is essentially equivalent to the traditional scalability scheme shown in FIG. 7. If the depth is equal to the total number of layers, the scheme becomes equivalent to the FGS method illustrated in FIG. 6. Thus, the progressive FGS coding scheme illustrated in FIG. 8 offers a compromise that provides the advantages of both the previous techniques, such as high coding efficiency and error recovery.

PFGS provides advantages when applied to video transmission over the Internet or over wireless channels. The encoded bit-stream can adapt to the available bandwidth of a channel without significant drifting occurring. FIG. 9 shows an example of the bandwidth adaptation property provided by progressive fine granularity scalability in a situation where a video sequence is represented by frames having a base layer and 3 enhancement layers. The thick dot-dashed line traces the video layers actually transmitted. At frame 2, there is significant reduction in bandwidth. The transmitter (server) reacts to this by dropping the bits representing the higher enhancement layers (layers 2 and 3). After frame 2, the bandwidth increases to some extent and the transmitter is able to transmit the additional bits representing two of the enhancement layers. By the time frame 4 is transmitted, the available bandwidth has further increased, providing sufficient capacity for the transmission of the base layer and all enhancement layers again. These operations do not require any re-encoding and re-transmission of the video bit-stream. All layers of each frame of the video sequence are efficiently coded and embedded in a single bit-stream.

The prior art scalable encoding techniques described above are based on a single interpretation of the encoded bit-stream. In other words, the decoder interprets the encoded bit-stream only once and generates reconstructed pictures. Reconstructed I and P pictures are used as reference pictures for motion compensation.

Generally, in the methods described above for using temporal references, the prediction references are temporally and spatially as close as possible to the picture, or to the area, which is to be coded. However, predictive coding is vulnerable to transmission errors, since an error affects all pictures that appear in a chain of predicted pictures following that containing the error. Therefore, a typical way to make a video transmission system more robust to transmission errors is to reduce the length of prediction chains.

Spatial, SNR, and FGS scalability techniques all provide a way to make the critical prediction paths smaller in terms of the number of bytes. A critical prediction path is that part of the bit-stream that needs to be decoded in order to obtain an acceptable representation of the video sequence contents. In bit-rate-scalable coding, the critical prediction path is the base layer of a GOP. It is convenient only to protect the critical prediction path properly rather than the whole layered bit-stream. However, it should be noted that conventional spatial and QSNR scalability coding, as well as FGS coding, decrease compression efficiency. Moreover, they require the transmitter to decide how to layer the video data during encoding

B-frames can be used instead of temporally corresponding INTER frames in order to shorten prediction paths. However, if the time between consecutive anchor frames is relatively long, the use of B-frames causes a reduction in compression efficiency. In this situation B-frames are predicted from anchor frames which are further away from each other in time and so the B-frames and reference frames from which they are predicted are less similar. This yields a worse predicted B-frame and consequently more bits are required to code the associated prediction error frame. In addition, as the time distance between the anchor frames increases, consecutive anchor frames are less similar. Again, this yields a worse predicted anchor image and more bits are required to code the associated prediction error image.

FIG. 10 illustrates the scheme normally used in the temporal prediction of P-frames. For simplicity B-frames are not considered in FIG. 10.

If the prediction reference of an INTER frame can be selected (as for example in the Reference Picture Selection mode of H.263), prediction paths can be shortened by predicting a current frame from a frame other than the one immediately proceeding it in natural numerical order. This is illustrated in FIG. 11. However, although reference picture selection can be used to reduce the temporal propagation of errors in a video sequence, it also has the effect of decreasing compression efficiency.

A technique known as Video Redundancy Coding (VRC) has been proposed to provide graceful degradation in video quality in response to packet losses in packet-switched networks. The principle of VRC is to divide a sequence of pictures into two or more threads in such a way that all pictures are assigned to one of the threads in a round-robin fashion. Each thread is coded independently. At regular intervals, all threads converge into a so-called Sync frame which is predicted from at least one of the individual threads. From this Sync frame, a new thread series is started. The frame rate within a given thread is consequently lower than the overall frame rate, half in the case of two threads, one third in the case of three threads and so on. This leads to a substantial coding penalty because of the generally larger differences between consecutive pictures in the same thread and the longer motion vectors typically required to represent motion-related changes between pictures within a thread. FIG. 12 shows VRC operating with two threads and three frames per thread.

If one of the threads is damaged in a VRC coded video sequence, for example because of a packet loss, it is likely that the remaining threads remain intact and can be used to predict the next Sync frame. It is possible to continue the decoding of the damaged thread, which leads to slight picture degradation, or to stop its decoding, which leads to a reduction in the frame rate. If the threads are reasonably short however, both forms of degradation only persist for a very short time, that is until the next Sync frame is reached. The operation of VRC when one of the two threads is damaged is shown in FIG. 13.

Sync frames are always predicted from undamaged threads. This means that the number of transmitted INTRA-pictures can be kept small, because there is generally no need for complete re-synchronisation. Correct Sync frame construction is only prevented if all threads between two Sync frames are damaged. In this situation, annoying artefacts persist until the next INTRA-picture is decoded correctly, as would have been the case without employing VRC.

Currently, VRC can be used with ITU-T H.263 video coding standard (version 2) if the optional Reference Picture Selection mode (Annex N) is enabled. However, there are no major obstacles of incorporating VRC into other video compression methods.

Backward prediction of P-frames has also been proposed as a method of shortening prediction chains. This is illustrated in FIG. 14, which shows a few consecutive frames of a video sequence. At point A the video encoder receives a request for an INTRA frame (I1) to be inserted into the coded video sequence. This request may arise in response to a scene cut, as the result of an INTRA frame request, a periodic INTRA frame refresh operation, or in response to an INTRA frame update request received as feedback from a remote receiver, for example. After a certain interval another scene cut, INTRA frame request or periodic INTRA frame refresh operation occurs (point B). Rather than inserting an INTRA frame immediately after the first scene cut, INTRA frame request or periodic INTRA frame refresh operation, the encoder inserts INTRA frame (I1) at a point in time approximately mid-way between the two INTRA frame requests. The frames (P2 and P3) between the first INTRA frame request and the INTRA frame I1 are predicted backwardly in sequence and in INTER format one from the other with I1 as the origin of the prediction chain. The remaining frames (P4 and P5) between INTRA frame I1 and the second INTRA frame request are predicted forwardly in INTER format in a conventional manner.

The benefit of this approach can be seen by considering how many frames must be successfully transmitted in order to enable decoding of frame P5. If conventional frame ordering, such as that shown in FIG. 15 is used, successful decoding of P5 requires that I1, P2, P3, P4 and P5 are transmitted and decoded correctly. In the method shown in FIG. 14, successful decoding of P5 only requires that I1, P4 and P5 are transmitted and decoded correctly. In other words, this method provides a greater certainty that P5 will be correctly decoded compared with a method that employs conventional frame ordering and prediction.

It should be noted, however, that the backwardly-predicted INTER frames cannot be decoded before I1 is decoded. Consequently, an initial buffering delay greater than the time between the scene cut and the following INTRA frame is required in order to prevent a pause in playback.

FIG. 16 shows a video communications system 10 which operates according to the ITU-T H.26L recommendation based upon test model (TML) TML 3 as modified by current recommendation's for TML4. The system 10 has a transmitter side 12 and a receiver side 14. It should be understood that since the system is equipped for bi-directional transmission and reception, the transmitter and receiver sides 12 and 14 can perform both transmission and reception functions and are inter-changeable. The system 10 comprises a video coding layer (VCL) and a network adaptation layer (NAL) with network awareness. The term network awareness means that the NAL is able to adapt the arrangement of data to suit the network. The VCL includes both waveform coding and entropy coding, as well as decoding functionality. When compressed video data is being transmitted, the NAL packetises the coded video data into service data units (packets) which are handed to a transport coder for transmission over a channel. When receiving compressed video data, the NAL de-packetises coded video data from service data units received from the transport decoder after transmission over a channel. The NAL is capable of partitioning a video bit-stream into coded block data and prediction error coefficients separately from other data more important for decoding and reconstruction of the image data, such as picture type and motion compensation information.

The main task of the VCL is to code video data in an efficient manner. However, as has been discussed in the foregoing, errors adversely affect efficiently coded data and so some awareness of possible errors is included. The VCL is able to interrupt the predictive coding chain and to take measures to compensate for the occurrence and propagation of errors. This can be done by:
i). interrupting the temporal prediction chain by introducing INTRA-frames and INTRA-coded macroblocks;
ii). interrupting error propagation by switching to an independent slice coding mode in which motion vector prediction is constrained to lie within slice bounds;
iii). introducing a variable length code which can be decoded independently, for example without adaptive arithmetic coding over frames; and
iv). by reacting rapidly to changes in the available bit rate of the transmission channel and adapting the bit-rate of the encoded video bit-stream so that packet losses are less likely to occur.

Additionally, the VCL identifies priority classes to support quality of service (QoS) mechanisms in networks.

Typically, video encoding schemes include information which describes the encoded video frames or pictures in the transmitted bit-stream. This information takes the form of syntax elements. A syntax element is a codeword or a group of codewords having similar functionality in the coding scheme. The syntax elements are classified into priority classes. The priority class of a syntax element is defined according to its coding and decoding dependencies, relative to other classes. Decoding dependencies result from the use of temporal prediction, spatial prediction and the use of variable length coding. The general rules for defining priority classes are as follows:
1. If syntax element A can be decoded correctly without knowledge of syntax element B and syntax element B cannot be decoded correctly without knowledge of syntax element A, then syntax element A has higher priority than syntax element B.
2. If syntax elements A and B can be decoded independently, the degree of influence on image quality of each syntax element determines its priority class.

The dependencies between syntax elements and the effect of errors in or loss of syntax elements due to transmission errors can be visualised as a dependency tree, such as that shown in FIG. 17, which illustrates the dependencies between the various syntax elements in the current H.26L test model. Erroneous or missing syntax elements only have an effect on the decoding of syntax elements which are in the same branch and further away from the root of the dependency tree. Therefore, the impact of syntax elements closer to the root of the tree on decoded image quality is greater than those in lower priority classes.

Typically, priority classes are defined on a frame-by-frame basis. If a slice-based image coding mode is used, some adjustment in the assignment of syntax elements to priority classes is performed.

Now referring to FIG. 17 in more detail, it can be seen that the current H.26L test model has 10 priority classes which range from Class 1, which has the highest priority, to Class 10, which has the lowest priority. The following is a summary of the syntax elements in each of the priority classes and a brief outline of the information carried by each syntax element:
Class 1: PSYNC, PTYPE: Contains the PSYNC, PTYPE syntax elements,
Class 2: MB_TYPE, REF_FRAME: Contains all macroblock types and reference frame syntax elements in a frame. For INTRA pictures/frames, this class contains no elements.
Class 3: IPM: Contains INTRA-prediction-Mode syntax element;

Class 4: MVD, MACC: Contains Motion Vectors and Motion accuracy syntax elements (TML-2). For INTRA pictures/frames, this class contains no elements.
Class 5: CBP-Intra: Contains all CBP syntax elements assigned to INTRA-macroblocks in one frame.
Class 6: LUM_DC-Intra, CHR_DC-Intra: Contains all DC luminance coefficients and all DC chrominance coefficients for all blocks in INTRA-MBs.
Class-7: LUM_AC-Intra, CHR_AC-Intra: Contains all AC luminance coefficients and all AC chrominance coefficients for all blocks in INTRA-MBs.
Class 8: CBP-Inter, Contains all CBP syntax elements assigned to INTER-MBs in a frame.
Class 9: LUM_DC-inter, CHR_DC-inter: Contains the first luminance coefficient of each block and the DC chrominance coefficients of all blocks in INTER-MBs.
Class 10: LUM_AC-Inter, CHR_AC-Inter: Contains the remaining luminance coefficients and chrominance coefficients of all blocks in INTER-MBs.

The main task of the NAL is to transmit the data contained within the priority classes in an optimal way, adapted to the underlying network. Therefore, a unique data encapsulation method is defined for each underlying network or type of network. The NAL carries out the following tasks:
1. It maps the data contained in the identified syntax element classes into service data units (packets).
2. It transfers the resulting service data units (packets) in a manner adapted to the underlying network.

The NAL may also provide error protection mechanisms.

Prioritisation of syntax elements used to code compressed video pictures into different priority classes simplifies adaptation to the underlying network. Networks supporting priority mechanisms obtain particular benefit from prioritisation of syntax elements. In particular, the prioritisation of syntax elements may be particularly advantageous when using:
i). priority methods in IP (such as the Resource Reservation Protocol, RVSP);
ii). Quality of Service (QoS) mechanisms in 3^{rd} generation mobile communications networks such as the Universal Mobile Telephone System (UMTS);
iii). Annex C or D of the H.223 Multiplexing Protocol for Multimedia Communication; and
iv). unequal error protection provided by underlying networks.

Different data/telecommunications networks usually have substantially different characteristics. For example, various packet based networks use protocols that employ minimum and maximum packet lengths. Some protocols ensure delivery of data packets in the correct order, others do not. Therefore, the merging of data for more than one class into a single-data packet or the splitting of data representing a given priority class amongst several data packets is applied as required.

When receiving compressed video data, the VCL checks, by using the network and the transmission protocols, that a certain class and all classes with higher priority for a particular frame can be identified and have been correctly received, that is without bit errors and that all the syntax elements have the correct length.

The coded video bit-stream is encapsulated in various ways depending on the underlying network and the application in use. In the following, some example encapsulation schemes are presented.

H.324 (Circuit-Switched Videophone)

The transport coder of H.324, namely H.223, has a maximum service data unit size of 254 bytes. Typically this is insufficient to carry a whole picture, and therefore the VCL is likely to divide a picture into multiple partitions so that each partition fits into one service data unit. Codewords are typically grouped into partitions based on their type, that is codewords of the same type are grouped into the same partition. The codeword (and byte) order of partitions is arranged with decreasing order of importance. If a bit error affects an H.223 service data unit carrying video data, the decoder may lose decoding synchronisation due to variable length coding of the parameters, and it will not be possible to decode the rest of the data in the service data unit. However, since the most important data appears at the beginning of the service data unit, the decoder is likely to be able to generate a degraded representation of the picture contents.

IP Videophone

For historical reasons, the maximum size of an IP packet is about 1500 bytes. It is beneficial to use IP packets which are as large as possible for two reasons:
1. IP network elements, such as routers, may become congested due to excessive IP traffic, causing internal buffer overflows. The buffers are typically packet-orientated, that is, they can contain a certain number of packets. Thus, in order to avoid network congestion, it is desirable to use rarely generated large packets rather than frequently generated small packets.
2. Each IP packet contains header information. A typical protocol combination used for real-time video communication, namely RTP/UDP/IP, includes a 40-byte header section per packet. A circuit-switched low-bandwidth dial-up link is often used when connecting to, an IP network. The packetisation overhead becomes significant in low-bit rate links if small packets are used.

Depending on the image size and complexity, an INTER-coded video picture may comprise sufficiently few bits to fit into a single IP packet.

There are numerous ways to provide unequal error protection in IP networks. These mechanisms include packet duplication, forward error correction (FEC) packets, Differentiated Services i.e. giving priority to certain packets in a network, and Integrated Services. (RSVP protocol). Typically, these mechanisms require that data with similar importance is encapsulated in one packet.

IP Video Streaming

As video streaming is a non-conversational application, there are no strict end-to-end delay requirements. Consequently, the packetisation scheme may utilise information from multiple pictures. For example, the data can be classified in a manner similar to the case of an IP videophone as described above, but with high-importance data from multiple pictures encapsulated in the same packet.

Alternatively, each picture or image slice can be encapsulated in its own packet. Data partitioning is applied so that the most important data appears at the beginning of the packets. Forward Error Correction (FEC) packets are calculated from a set of already transmitted packets. The FEC algorithm is selected so that it protects only a certain number of bytes appearing at the beginning of the packets. At the receiving end, if a normal data packet is lost, the beginning of the lost data packet can be corrected using the FEC packet. This approach is, proposed in A. H. Li, J. D. Villasenor, “A generic Uneven Level Protection (ULP) proposal for Annex I of H.323”, ITU-T, SG6, Question 15, document Q15-J-61, 16May 2000.

### SUMMARY OF THE INVENTION

According to a first aspect of the invention there is provided a method for encoding a video signal to produce a bit-stream comprising the steps of:
encoding a first complete frame by forming a first portion of the bit-stream comprising information for reconstruction of the first complete frame the information being prioritised into high and low priority information;
defining a first virtual frame on the basis of a version of the first complete frame constructed using the high priority information of the first complete frame in the absence of at least some of the low priority information of the first complete frame; and
encoding a second complete frame by forming a second portion of the bit-stream comprising information for use in reconstruction of the second complete frame such that the second complete frame can be reconstructed on the basis of the first virtual frame and the information comprised by the second portion of the bit-stream rather than on the basis of the first complete frame and the information comprised by the second portion of the bit-stream.

Preferably the method also comprises the steps of:
prioritising the information of the second complete frame into high and low priority information;
defining a second virtual frame on the basis of a version of the second complete frame constructed using the high priority information of the second complete frame in the absence of at least some of the low priority information of the second complete frame; and
encoding a third complete frame by forming a third portion of the bit-stream comprising information for use in reconstruction of the third complete frame such that the third complete frame can be reconstructed on the basis of the second complete frame and the information comprised by the third portion of the bit-stream.

According to a second aspect of the invention there is provided a method for encoding a video signal to produce a bit-stream comprising the steps of:

encoding a first complete frame by forming a first portion of the bit-stream comprising information for reconstruction of the first complete frame the information being prioritised into high and low priority information;
defining a first virtual frame on the basis of a version of the first complete frame constructed using the high priority information of the first complete frame in the absence of at least some of the low priority information of the first complete frame;
encoding a second complete frame by forming a second portion of the bit-stream comprising information for use in reconstruction of the second complete frame the information being prioritised into high and low priority information the second frame being encoded such that it can be reconstructed on the basis of the first virtual frame and the information comprised by the second portion of the bit-stream rather on the basis of the of the first complete frame and the information comprised by the second portion of the bit-stream;
defining a second virtual frame on the basis of a version of the second complete frame constructed using the high priority information of the second complete frame in the absence of at least some of the low priority information of the second complete frame; and
encoding a third complete frame which is predicted from the second complete frame and follows it in sequence by forming a third portion of the bit-stream comprising information for use in reconstruction of the third complete frame such that the third complete frame can be reconstructed on the basis of the second complete frame and the information comprised by the third portion of the bit-stream.

The first virtual frame can be constructed, using the high priority information of the the first portion of the bit-stream in the absence of at least some of the low priority information of the first complete frame and using a previous virtual frame as a prediction reference. Other virtual frames can be constructed based on previous virtual frames. Accordingly, a chain of virtual frames may be provided.

Complete frames are complete in the sense that an image capable of display can be formed. This is not necessarily true for the virtual frames.

The first complete frame may be an INTRA coded complete frame, in which case the first portion of the bit-stream comprises information for the reconstruction of the INTRA coded complete frame.

The first complete frame may be an INTER coded complete frame, in which case the first portion of the bit-stream comprises information for the reconstruction of the INTER coded complete frame with respect to a reference frame which may be a complete reference frame or a virtual reference frame.

In one embodiment, the invention is a scalable coding method. In this case, the virtual frames may be interpreted as being a base layer of a scalable bit-stream.

In another embodiment of the invention more than one virtual frame is defined from the information of the first complete frame, each of said more than one virtual frames being defined using different high priority information of the first complete frame.

In a further embodiment of the invention more than one virtual frame is defined from the information of the first complete frame, each of said more than one virtual frames being defined using different high priority information of the first complete frame formed using a different prioritisation of the information of the first complete frame.

Preferably the information for the reconstruction of a complete frame is prioritised into high and low priority information according to its significance in reconstructing the complete frame.

Complete frames may be base layers of a scalable frame structure.

When predicting a complete frame using a preceding frame, in such a prediction step, the complete frame may be predicted based an a previous complete frame and in a subsequent prediction step, the complete frame may be predicted based on a virtual frame. In this way, the basis of prediction may change from prediction step to prediction step. This change can occur on a predetermined basis or from time to time determined by other factors such as the quality of a link across which the encoded video signal is to be transmitted. In an embodiment of the invention the change is initiated by a request received from a receiving decoder.

Preferably a virtual frame is one which is formed using high priority information and deliberately not using low priority information. Preferably a virtual frame is not displayed. Alternatively, if it is displayed, it is used as an alternative to a complete frame. This may be the case if the complete frame is not available due to a transmission error.

The invention enables an improvement in the coding efficiency when shortening a temporal prediction path. It further has the effect of increasing the resilience of an encoded video signal to degradations resulting from loss or corruption of data in a bit-stream carrying information for the reconstruction of the video signal.

Preferably the information comprises codewords.

Virtual frames may be constructed not exclusively from or defined by high priority information but may also be constructed from or defined by some low priority information.

A virtual frame may be predicted from a prior virtual frame using forward prediction of virtual frames. Alternatively or additionally, a virtual frame may be predicted from a subsequent virtual frame using backward-prediction of virtual frames. Backward prediction of INTER frames has been described in the foregoing in connection with FIG. 14. It will be understood that this principle can readily be applied to virtual frames.

A complete frame may be predicted from a prior complete or virtual frame using forward prediction frames. Alternatively or additionally, a complete frame may be predicted from a subsequent complete or virtual frame using backward-prediction.

If a virtual frame is not only defined by high priority information but is also defined by some low priority information, the virtual frame may be decoded using both its high and low priority information and may further be predicted on the basis of another virtual frame.

Decoding of a bit-stream for a virtual frame may use a different algorithm from that used in decoding of a bit-stream for a complete frame. There may be multiple algorithms for decoding virtual frames. Selection of a particular algorithm may be signalled in the bit-stream.

In the absence of low priority information, it may be replaced by default values. The selection of the default values may vary and the correct selection may be signalled in the bit-stream.

According to a third aspect of the invention there is provided a method for decoding a bit-stream to produce a video signal comprising the steps of:
decoding a first complete frame from a first portion of the bit-stream comprising information for reconstruction of the first complete frame the information being prioritised into high and low priority information;
defining a first virtual frame on the basis of a version of the first complete frame constructed using the high priority information of the first complete frame in the absence of at least some of the low priority information of the first complete frame; and
predicting a second complete frame on the basis of the first virtual frame and information comprised by a second portion of the bit-stream rather than on the basis of the first complete frame and information comprised by the second portion of the bit-stream.

Preferably the method also comprises the steps of:
defining a second virtual frame on the basis of a version of the second complete frame constructed using the high priority information of the second complete frame in the absence of at least some of the low priority information of the second complete frame; and
predicting a third complete frame on the basis of the second complete frame and information comprised by a third portion of the bit-stream.

According to a fourth aspect of the invention there is provided a method for decoding a bit-stream to produce a video signal comprising the steps of:
decoding a first complete frame from a first portion of the bit-stream comprising information for reconstruction of the first complete frame the information being prioritised into high and low priority information;
defining a first virtual frame on the basis of a version of the first complete frame constructed using the high priority information of the first complete frame in the absence of at least some of the low priority information of the first complete frame;
predicting a second complete frame on the basis of the first virtual frame and information comprised by a second portion of the bit-stream rather than on the basis of the first complete frame and information comprised by the second portion of the bit-stream;
defining a second virtual frame on the basis of a version of the second complete frame constructed using the high priority information of the second complete frame in the absence of at least some of the low priority information of the second complete frame; and
predicting a third complete frame on the basis of the second complete frame and information comprised by a third portion of the bit-stream.

The first virtual frame can be constructed using the high priority information of the the first portion of the bit-stream in the absence of at least some of the low priority information of the first complete frame and using a previous virtual frame as a prediction reference. Other virtual frames can be constructed based on previous virtual frames. A complete frame may be decoded from a virtual frame. A complete frame may be decoded from a prediction chain of virtual frames.

According to a fifth aspect of the invention there is provided a video encoder for encoding a video signal to produce a bit-stream comprising:
a complete frame encoder for forming a first portion of the bit-stream of a first complete frame containing information for reconstruction of the first complete frame the information being prioritised into high and low priority information;
a virtual frame encoder defining at least a first virtual frame on the basis of a version of the first complete frame constructed using the high priority information of the first complete frame in the absence, of at least some of the low priority information of the first complete frame; and
a frame predictor for predicting a second complete frame on the basis of the first virtual frame and information comprised by a second portion of the bit-stream rather than on the basis of the first complete frame and the information comprised by the second portion of the bit-stream.

Preferably the complete frame encoder comprises the frame predictor.

In an embodiment of the invention, the encoder sends a signal to the decoder to indicate which part of the bit-stream for a frame is sufficient to produce an acceptable picture to replace a full-quality picture in case of a transmission error or loss. The signalling may be included in the bit-stream or it may be transmitted separately from the bit-stream.

Rather than applying to a frame, the signalling may apply to a part of a picture, for example a slice, a block, a macroblock or a group of blocks. Of course, the whole method may apply to image segments.

The signalling may indicate which one of multiple pictures may be sufficient to produce an acceptable picture to replace a full-quality picture.

In an embodiment of the invention, the encoder can send a signal to the decoder to indicate how to construct a virtual frame. The signal can indicate prioritisation of the information for a frame.

According to a further embodiment of the invention, the encoder can send a signal to the decoder to indicate how to construct a virtual spare reference picture that is used if the actual reference picture is lost or too corrupted.

According to a sixth aspect of the invention there is provided a decoder for decoding a bit-stream to produce a video, signal comprising:
a complete frame decoder for decoding a first complete frame from a first portion of the bit-stream containing information for reconstruction of the first complete frame the information being prioritised into high and low priority information;
a virtual frame decoder for forming a first virtual frame from the first portion of the bit-stream of the first complete frame using the high priority information of the first complete frame in the absence of at least some of the low priority information of the first complete frame; and
a frame predictor for predicting a second complete frame on the basis of the first virtual frame and information comprised by a second portion of the bit-stream rather than on the basis of the first complete frame and the information comprised by the second portion of the bit-stream.

Preferably the complete frame decoder comprises the frame predictor.

Because the low priority information is not used in the construction of virtual frames, loss of such low priority information does not adversely affect the construction of virtual frames.

In the case of Reference Picture Selection, the encoder and the decoder may be provided with multi-frame buffers for storing complete frames and a multi-frame buffer for storing virtual frames.

Preferably, a reference frame used to predict another frame may be selected, for example by the encoder, the decoder or both. The selection of the reference frame can be made separately for each frame, picture segment, slice, macroblock, block or whatsoever sub-picture element. A reference frame can be any complete or virtual frame that is accessible or that can be generated both in the encoder and in the decoder.

In this way, each complete frame is not restricted to a single virtual frame but may be associated with a number of different virtual frames, each having a different way to classify the bit-stream for the complete frame. These different ways to classify, the bit-stream may be different reference (virtual or complete) picture(s) for motion compensation and/or a different way of decoding the high priority part of the bit-stream.

Preferably feedback is provided from the decoder to the encoder. This feedback may be in the form of an indication that concerns codewords of one or more specified pictures. The indication may indicate that codewords have been received, have not been received or have been received in a damaged state. This may cause the encoder to change the prediction reference used in motion compensated prediction of a subsequent frame from a complete frame to a virtual frame. Alternatively, the indication may cause the encoder to re-send codewords which have not been received or which have been received in a damaged state. The indication may specify codewords within a certain area within one picture or may specify codewords within a certain area in multiple pictures

According to a seventh aspect of the invention there is provided a video communications system for encoding a video signal into a bit-stream and for decoding the bit-stream into the video signal, the system comprising an encoder and a decoder the encoder comprising:
a complete frame encoder for forming a first portion of the bit-stream of a first complete frame containing information for reconstruction of the first complete frame the information being prioritised into high and low priority information;
a virtual frame encoder defining a first virtual frame on the basis of a version of the first complete frame constructed using the high priority information of the first complete frame in the absence of at least some of the low priority information of the first complete frame; and
a frame predictor for predicting a second complete frame on the basis of the first virtual frame and information comprised by a second portion of the bit-stream rather than on the basis of the first complete frame and the information comprised by the second portion of the bit-stream;

and the decoder comprising:
a complete frame decoder for decoding a first complete frame from the first portion of the bit-stream;
a virtual frame decoder for forming the first virtual frame from the first portion of the bit-stream using the high priority information of the first complete frame in the absence of at least some of the low priority information of the first complete frame; and
a frame predictor for predicting a second complete frame on the basis of the first virtual frame and information comprised by the second portion of the bit-stream rather on the basis of than the first complete frame and the information comprised by the second portion of the bit-stream.

Preferably the complete frame encoder comprises the frame predictor.

According to an eighth aspect of the invention there is provided a video communications terminal comprising a video encoder for encoding a video signal to produce a bit-stream, the video encoder comprising:
a complete frame encoder for forming a first portion of the bit-stream of a first complete frame containing information for reconstruction of the first complete frame the information being prioritised into high and low priority information;
a virtual frame encoder defining at least a first virtual frame on the basis of a version of the first complete frame constructed using the high priority information, of the first complete frame in the absence of at least some of the low priority information of the first complete frame; and
a frame predictor for predicting a second complete frame on the basis of the first virtual frame and information comprised by a second portion of the bit-stream rather than on the basis of the first complete frame and the information comprised by the second portion of the bit-stream.

Preferably the complete frame encoder comprises the frame predictor.

According to a ninth aspect of the invention there is provided a video communications terminal comprising a decoder for decoding a bit-stream to produce a video signal, the decoder comprising:
a complete frame decoder for decoding a first complete frame from a first portion of the bit-stream containing information for reconstruction of the first complete frame the information being prioritised into high and low priority information;
a virtual frame decoder for forming a first virtual frame from the first portion of the bit-stream of the first complete frame using the high priority information of the first complete frame in the absence of at least some of the low priority information of the first complete frame; and
a frame predictor for predicting a second complete frame on the basis of the first virtual frame and information comprised by a second portion of the bit-stream rather than on the basis of the first complete frame and the information comprised by the second portion of the bit-stream.

Preferably the complete frame decoder comprises the frame predictor.

According to an tenth aspect of the invention there is provided a computer program for operating a computer as a video encoder for encoding a video signal to produce a bit-stream comprising:
computer executable code for encoding a first complete frame by forming a first portion of the bit-stream containing information for reconstruction of the first complete frame the information being prioritised into high and low priority information;
computer executable code for defining a first virtual frame on the basis of a version of the first complete frame constructed using the high priority information of the first complete frame in the absence of at least some of the low priority information of the first complete frame; and
computer executable code for encoding a second complete frame by forming a second portion of the bit-stream comprising information for reconstruction of the second complete frame such that the second complete frame the second complete frame to be reconstructed on the basis of the virtual frame and the information comprised by the second portion of the bit-stream rather than on the basis of the first complete frame and the information comprised by the second portion of the bit-stream.

According to an eleventh aspect of the invention there is provided a computer program for operating a computer as a video decoder for decoding a bit-stream to produce a video signal comprising:
computer executable code for decoding a first complete frame from a portion of the bit-stream containing information for reconstruction of the first complete frame the information being prioritised into high and low priority information;
computer executable code for defining a first virtual frame on the basis of a version of the first complete frame constructed using the high priority information of the first complete frame in the absence of at least some of the low priority information of the first complete frame; and
computer executable code for predicting a second complete frame on the basis of the first virtual frame and information comprised by a second portion of the bit-stream rather than on the basis of the first complete frame and information comprised by the second portion of the bit-stream.

Preferably the computer programs of the tenth and eleventh aspects are stored on a data storage medium. This may be a portable data storage medium or a data storage medium in a device. The device may be portable, for example a laptop, a personal digital assistant or a mobile telephone.

References to “frames” in the context of the invention is intended also to include parts of frames, for example slices, blocks and MBs, within a frame.

Compared to PFGS, the invention provides better compression efficiency. This is because it has a more flexible scalability hierarchy. It is possible for PFGS and the invention to exist in the same coding scheme. In this case, the invention operates underneath the base layer of PFGS.

The invention introduces the concept of virtual frames, which are constructed using the most significant part of the encoded information produced by a video encoder. In this context, the term “most significant” refers to information in the coded representation of a compressed video frame that has the greatest influence on the successful reconstruction of the frame. For example, in the context of the syntax elements used in the coding of compressed video data according to ITU-T recommendation H.263, the most significant information in the encoded bit-stream can be considered to comprise those syntax elements nearer the root of the dependency tree defining the decoding relationship between syntax elements. In other words, those syntax elements which must be decoded successfully in order to enable the decoding of further syntax elements can be considered to represent the more significant/higher priority information in the encoded representation of the compressed video frame.

The use of virtual frames provides a new way of enhancing the error resilience of an encoded bit-stream. Specifically, the invention introduces a new way of performing motion compensated predictions in which an alternative prediction path generated using virtual frames is used. It should be noted that in the prior art methods previously described, only complete frames, that is, video frames reconstructed using the complete encoded information for a frame, are used as references for motion compensation. In the method according to the invention, a chain of virtual frames is constructed using the higher importance information of the encoded video frame, together with motion compensated prediction within the chain. The prediction path comprising virtual frames is provided in addition to a conventional prediction path which uses the full information of the encoded video frames. It should be noted that the term “complete” refers to the use of the full information available for use in the reconstruction of a video frame. If the video coding scheme in question produces a scalable bit-stream, then the term “complete” means the use of all the information provided for a given layer of the scalable structure. It should further be noted that virtual frames are generally not intended to be displayed. In some situations, depending on the kind of information used in their construction, virtual frames may not be appropriate for, or capable of, display. In other situations, virtual frames may be appropriate for or capable of display, but in any case are not displayed and are only used to provide an alternative means of motion compensated prediction, as described in general terms above. In other embodiments of the invention, virtual frames may be displayed. It should also be noted that it is possible to prioritise the information from the bit-stream in different ways to enable construction of different kinds of virtual frames.

The method according to the invention has a number of advantages when compared with the prior art error resilience methods described above. For example, considering a group of pictures (GOP) that is encoded to form a sequence: of frames I0, P1, P2, P3, P4, P5 and P6, a video encoder implemented according to the present invention can be programmed to encode INTER frames P1, P2 and P3 using motion compensated prediction in a prediction chain starting from INTRA frame I0. At the same time, the encoder produces a set of virtual frames I0′, P1′, P2′ and P3′. Virtual INTRA frame I0′ is constructed using the higher priority information representing I0 and similarly, virtual INTER frames P1′, P2′ and P3′ are constructed using the higher priority information of complete INTER frames P1, P2 and P3 respectively and are formed in a motion compensated prediction chain starting from virtual INTRA frame I0′. In this example, the virtual frames are not intended for display and the encoder is programmed in such a way that when it reaches frame P4, the motion prediction reference is chosen as virtual frame P3′ rather than complete frame P3. Subsequent frames P5 and P6 are then encoded in a prediction chain from P4 using complete frames as their prediction references.

This approach can be viewed as being similar to the reference frame, selection mode provided e.g. by H.263. However, in the method according to the invention, the alternative reference frame, that is virtual frame P3′, bears a much greater similarity to the reference frame that would otherwise have been used in the prediction of frame P4 (namely, frame P3), than an alternative reference frame (for example P2) that would have been used according to a conventional reference picture selection scheme. This can be easily justified by remembering that P3′ is actually constructed from a subset of the encoded information that describes P3 itself, that is the information most important for the decoding of frame P3. For this reason, less prediction error information is likely to be needed in connection with the use of an virtual reference frame than would be expected if conventional reference picture selection were used. In this way the invention provides a gain in compression efficiency compared with conventional reference picture selection methods.

It should also be noted that if a video encoder is programmed in such a way that it periodically uses a virtual frame as a prediction reference instead of a complete frame, it is likely that the accumulation and propagation of visual artefacts at a receiving decoder caused by transmission errors affecting the bit-stream will be reduced or prevented.

Effectively, the use of virtual frames according to the invention is a method of shortening prediction paths in motion compensated prediction. In the example prediction scheme presented above frame P4 is predicted using a prediction chain that starts from virtual frame I0′ and progresses through virtual; frames P1′, P2′ and P3′. Although the length of the prediction path in terms of the number of frames is the same as in a conventional motion compensated prediction scheme in which frames I0, P1, P2 and P3 would be used, the number of bits that must be received correctly in order to ensure the error-free reconstruction of P4 is less if the prediction chain from I0′ to P3′ is used in the prediction of P4.

In the event that a receiving decoder can only reconstruct a particular frame, for example P2, with a certain degree of visual distortion, due to the loss or corruption of information in the bit-stream transmitted from the encoder, the decoder may request the encoder to encode the next frame in the sequence, e.g. P3, with respect to virtual frame P2′. If the error occurred in the low priority information representing P2, it is likely that prediction of P3 with respect to P2′ will have the effect of limiting or preventing the propagation of the transmission error to P3 and subsequent frames in the sequence. Thus, the need for complete re-initialisation of the prediction path, that is the request for and transmission of an INTRA frame update is reduced. This has significant advantages in low bit-rate networks, where transmission of a full INTRA frame in response to an INTRA update request may lead to undesirable pauses in the display of the reconstructed video sequence at the decoder.

The advantages described above can be further enhanced if the method according to the invention is used in combination with unequal error protection of the bit-stream transmitted to the decoder. The term “unequal error protection” is used here to mean any method which provides the higher priority information of an encoded video frame with a greater degree of error-resilience in the bit-stream than the associated lower priority information of the encoded frame. For example, unequal error protection can involve the transmission of packets containing high and low priority information, in such a way that the high priority information packets are less likely to be lost. Thus, when unequal error protection is used in connection with the method of the invention, the higher priority/more important information for reconstructing video frames is more likely to be received correctly. Consequently, there is a higher probability that the all the information required to construct the virtual frames will be received without error. Therefore, it is evident that the use of unequal error protection in connection with the method of the invention further increases the error resilience of an encoded video sequence. Specifically, when a video encoder is programmed to periodically use a virtual frame as a reference for motion compensated prediction, there is a high probability that all the information necessary for error-free reconstruction of the virtual reference frame will be received correctly at the decoder. Hence there is a higher probability that any complete frames predicted from the virtual reference frame will be constructed without error.

The invention also enables a high-importance part of a received bit-stream to be reconstructed and used to conceal loss or corruption of a low-importance part of the bit-stream. This can be achieved by enabling the encoder to send the decoder an indication specifying which part of the bit-stream for a frame is sufficient to produce an acceptable reconstructed picture. This acceptable reconstruction can be used to replace a full-quality picture in the event of a transmission error or loss. The signalling required to provide the indication to the decoder can be included in the video bit-stream itself or can be transmitted to the decoder, separately from the video bit-stream, using a control channel, for example. Using the information provided by the indication, the decoder decodes the high-importance part of the information for the frame and replaces the low-importance part by default values, in order to obtain an acceptable picture for display. The same principle can also be applied to sub-pictures (slices etc.) and to multiple pictures. In this way the invention further allows error concealment to be controlled in an explicit way.

In another error concealment approach, the encoder can provide the decoder with an indication of how to construct a virtual spare reference picture that can be used as a reference frame for motion compensated prediction if the actual reference picture is lost or becomes too corrupted to be used.

The invention can further be classified as a new type of SNR scalability that is more flexible than prior art scalability techniques. However, as explained above, according, to the invention, the virtual frames used for motion compensated prediction do not necessarily represent contents of any uncompressed picture appearing in the sequence. In known scalability techniques, on the other hand, the reference pictures used in motion compensated prediction do represent corresponding original (i.e. uncompressed) pictures in the video sequence. Since virtual frames are not intended to be displayed, unlike, the base layer in the traditional scalability schemes, it is not necessary for the encoder to construct virtual frames that are acceptable for display. Consequently the compression efficiency achieved by the invention is close to a one-layer coding approach.

### BRIEF DESCRIPTION OF THE DRAWINGS

The invention will now be described, by way of example only, with reference to the accompanying drawings in which:

FIG. 1 shows a video transmission system;

FIG. 2 illustrates the prediction of INTER (P) and bi-directionally predicted (B) pictures;

FIG. 3 shows an IP multicasting system;

FIG. 4 shows SNR scalable pictures;

FIG. 5 shows spatial scalable pictures;

FIG. 6 shows prediction relationships in fine granularity scalable coding;

FIG. 7 shows conventional prediction relationships used in scalable coding;

FIG. 8 shows prediction relationships in progressive fine granularity scalable coding;

FIG. 9 illustrates channel adaptation in progressive fine granularity scalability;

FIG. 10 shows conventional temporal prediction;

FIG. 11 illustrates the shortening of prediction paths using Reference Picture Selection;

FIG. 12 illustrates the shortening of prediction paths using Video Redundancy Coding;

FIG. 13 shows Video-Redundancy Coding dealing with damaged threads;

FIG. 14 illustrates the shortening of prediction paths by re-positioning an INTRA frame and applying backward prediction of INTER frames;

FIG. 15 shows conventional frame prediction relationships following an INTRA frame;

FIG. 16 shows a video transmission system;

FIG. 17 shows dependencies of syntax elements in the H.26L TML-4 test model;

FIG. 18 illustrates an encoding procedure according to the invention;

FIG. 19 illustrates a decoding procedure according to the invention;

FIG. 20 shows a modification of the decoding procedure of FIG. 19;

FIG. 21 illustrates a video coding method according to the invention;

FIG. 22 illustrates another video coding method according to the invention;

FIG. 23 shows a video transmission system according to the invention; and

FIG. 24 shows a video transmission system utilising ZPE-pictures.

### DETAILED DESCRIPTION

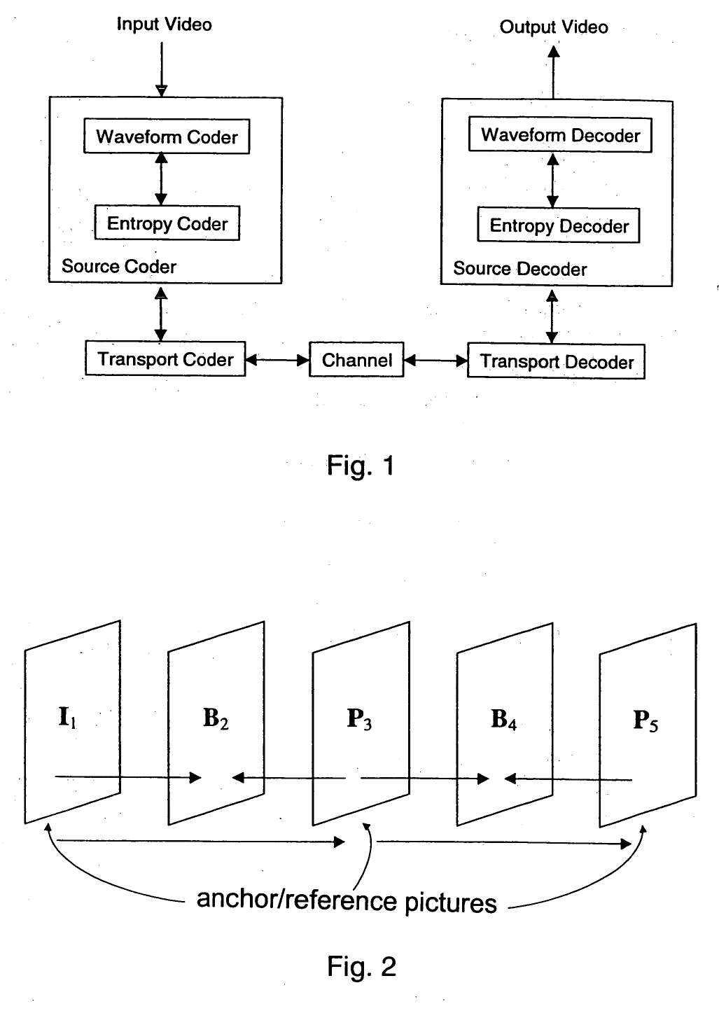

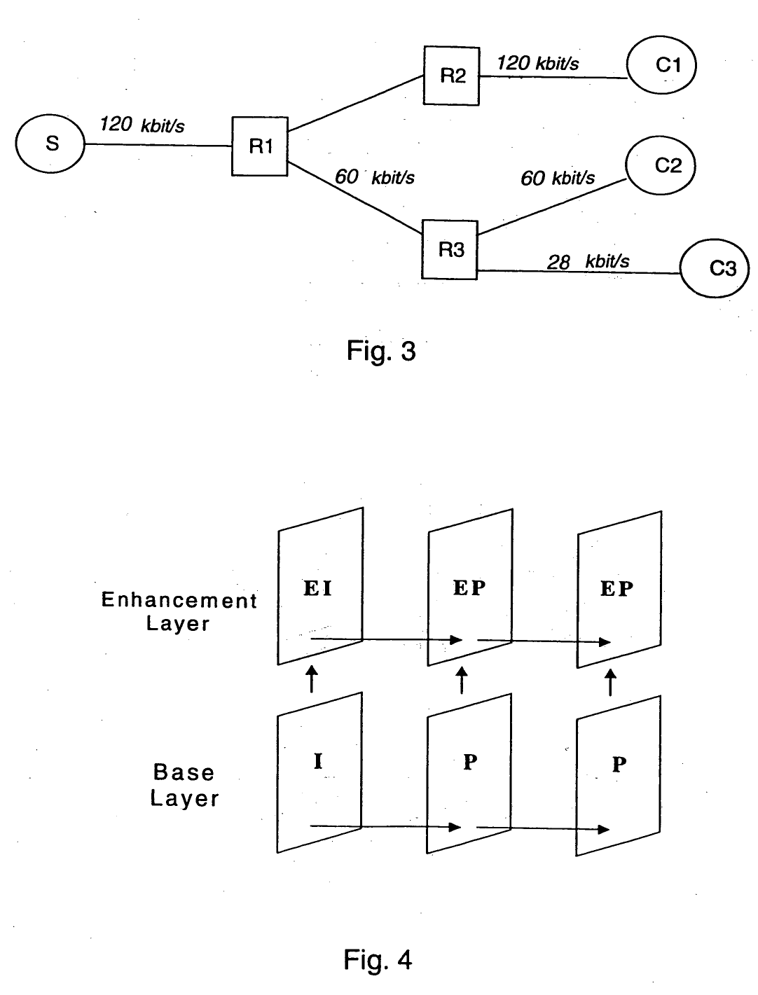

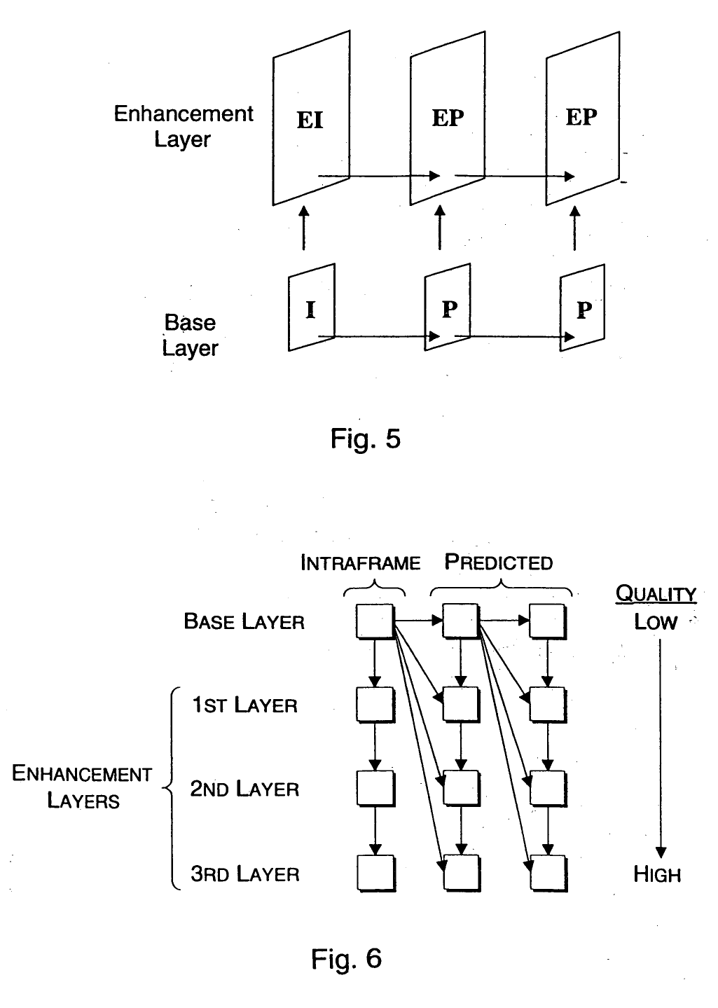

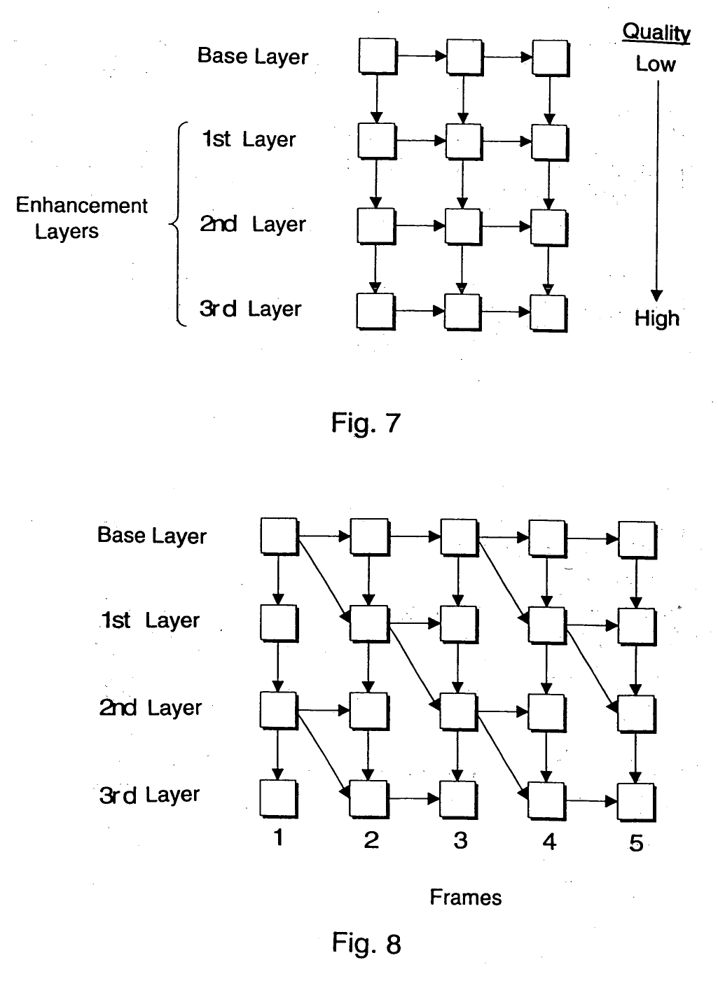

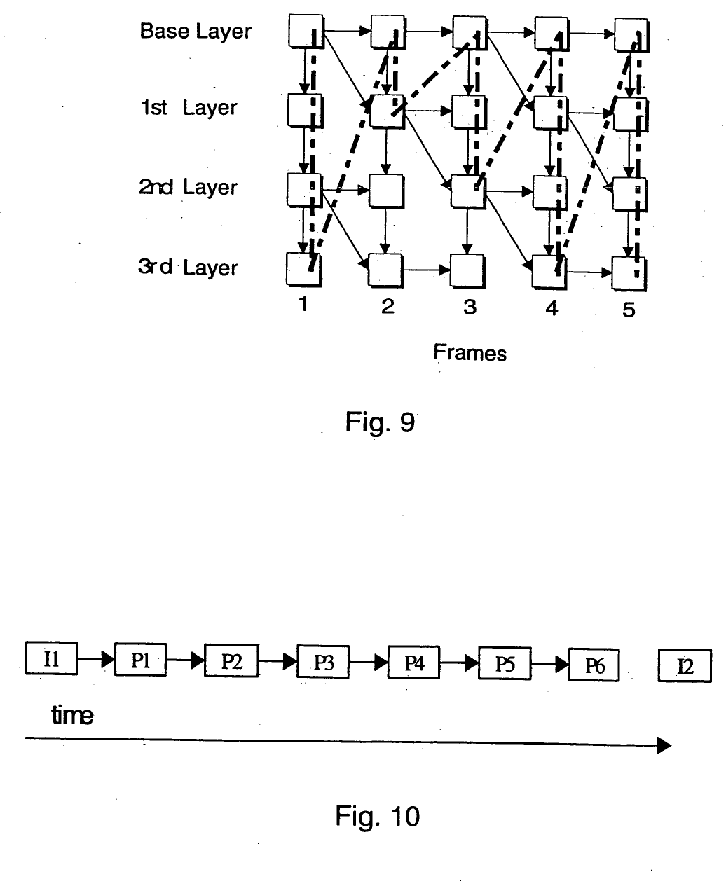

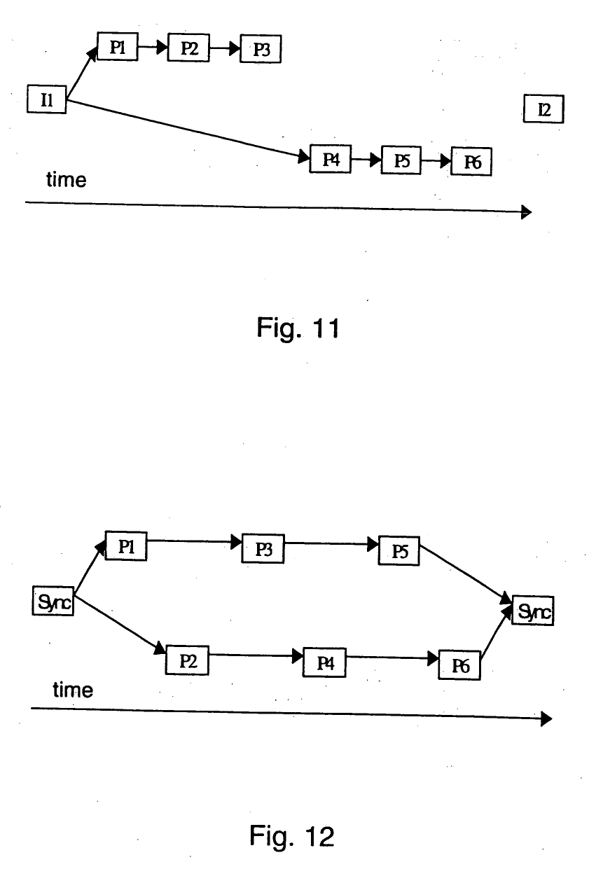

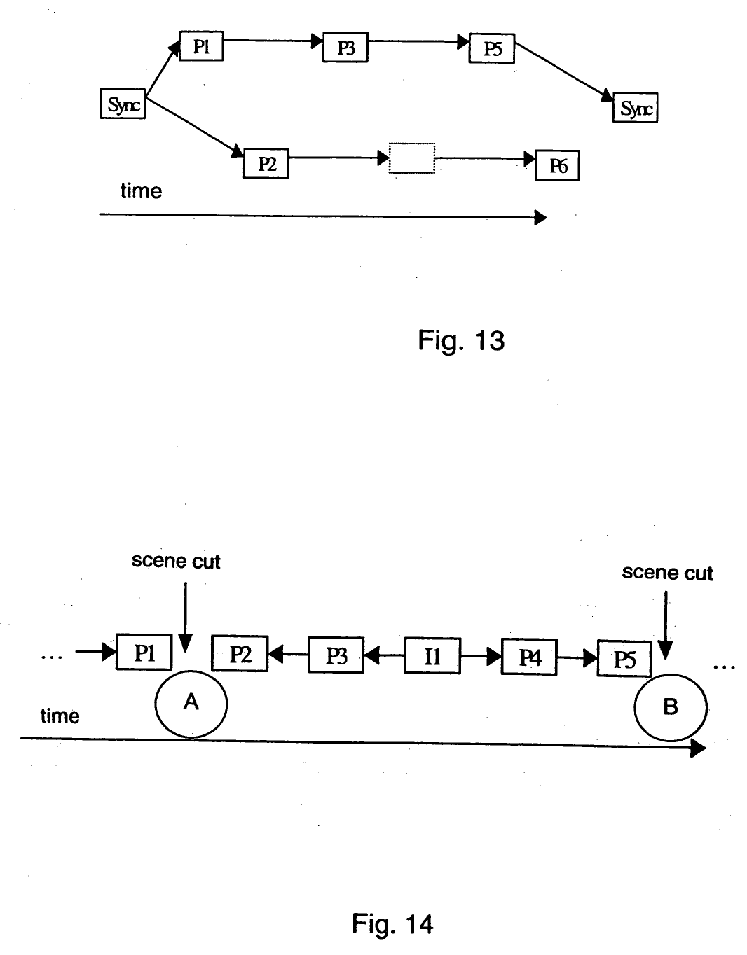

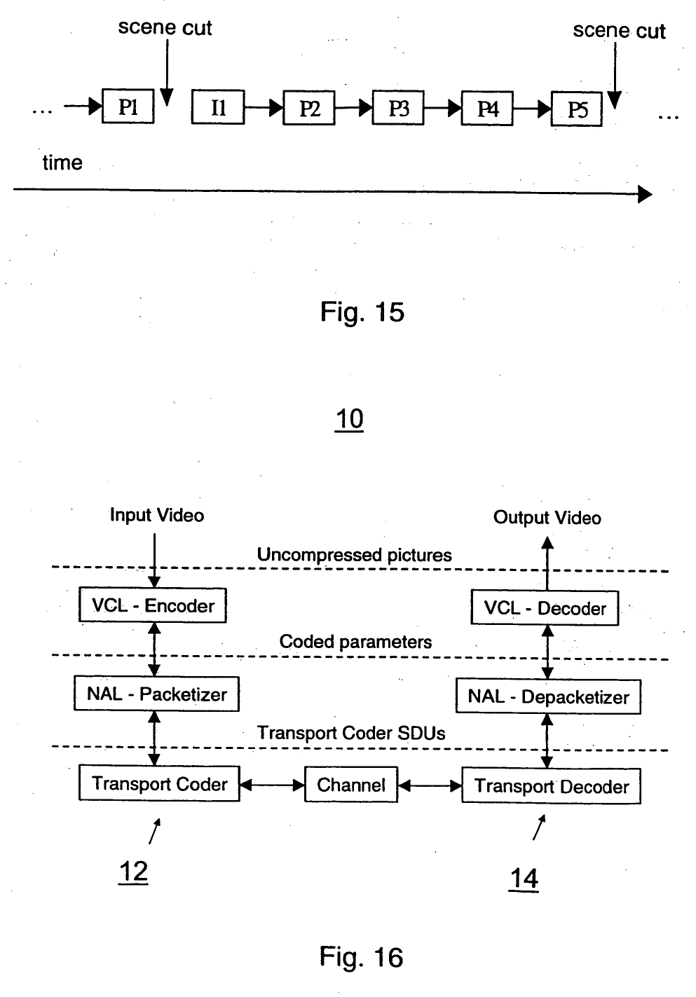

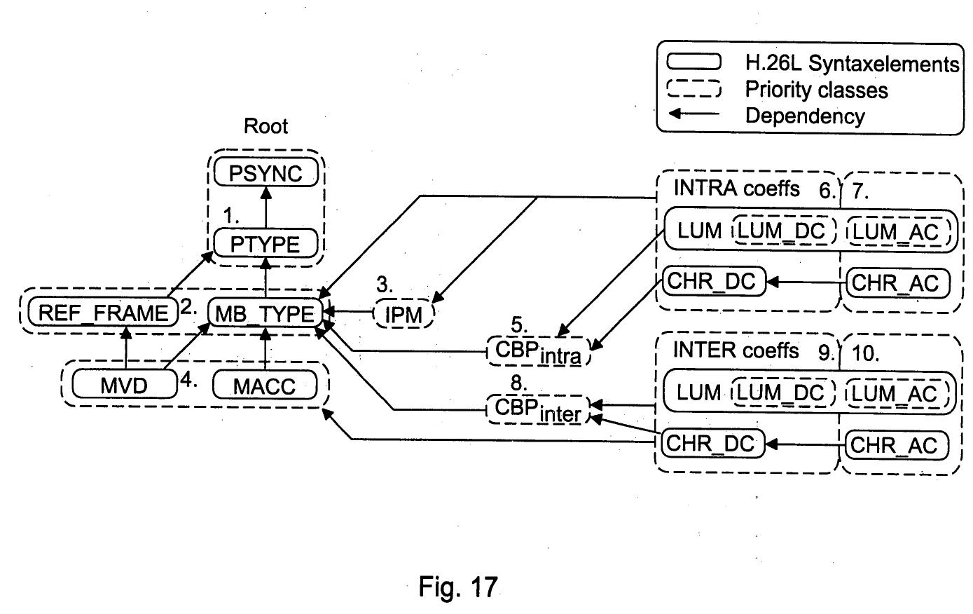

FIGS. 1 to 17 have been described in the foregoing.

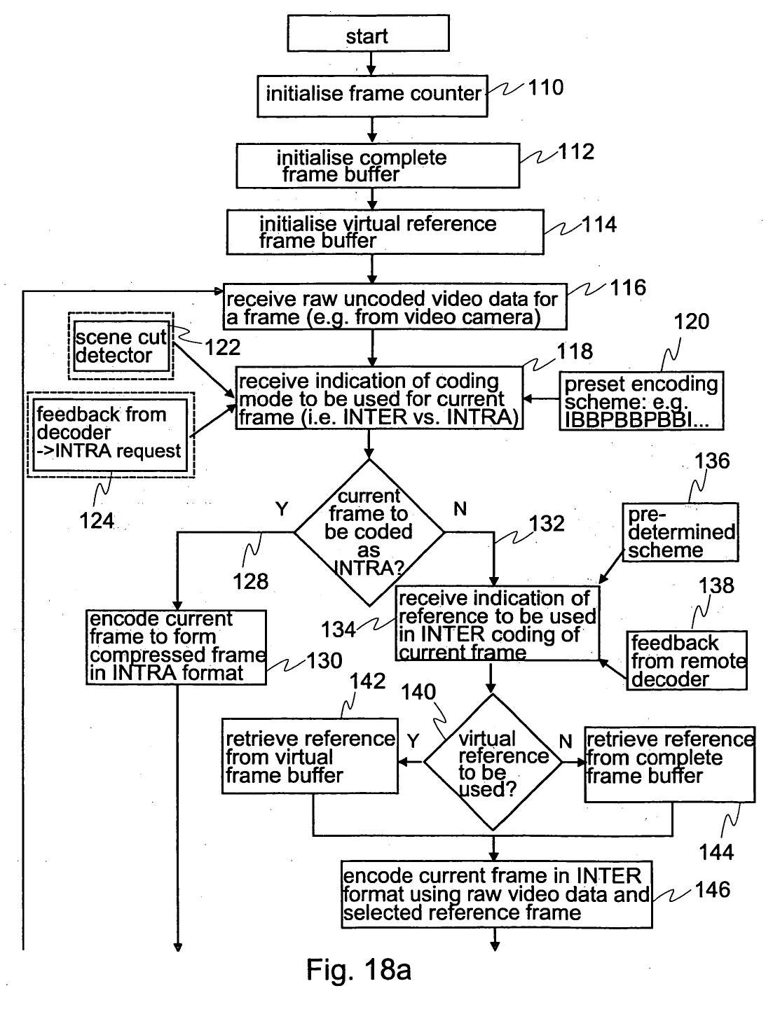

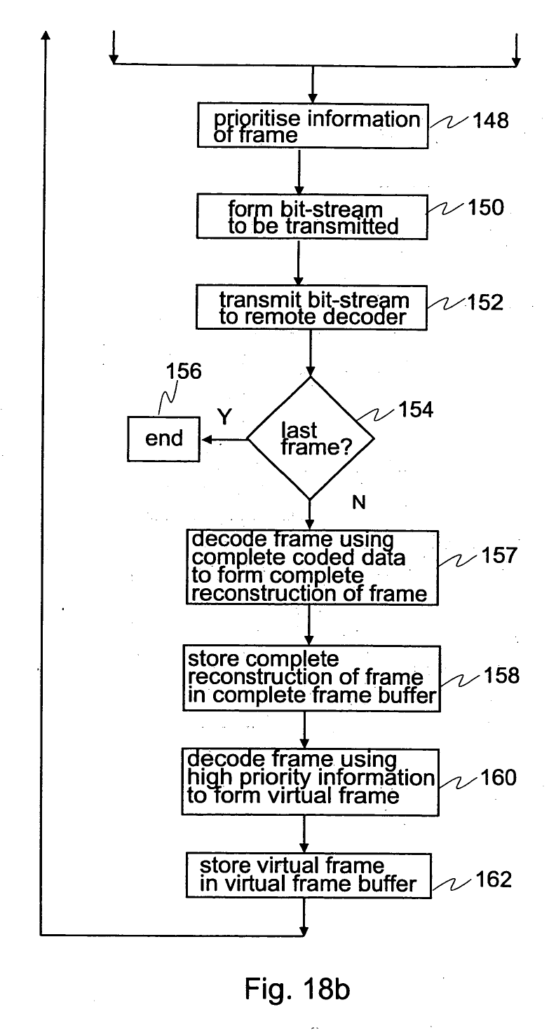

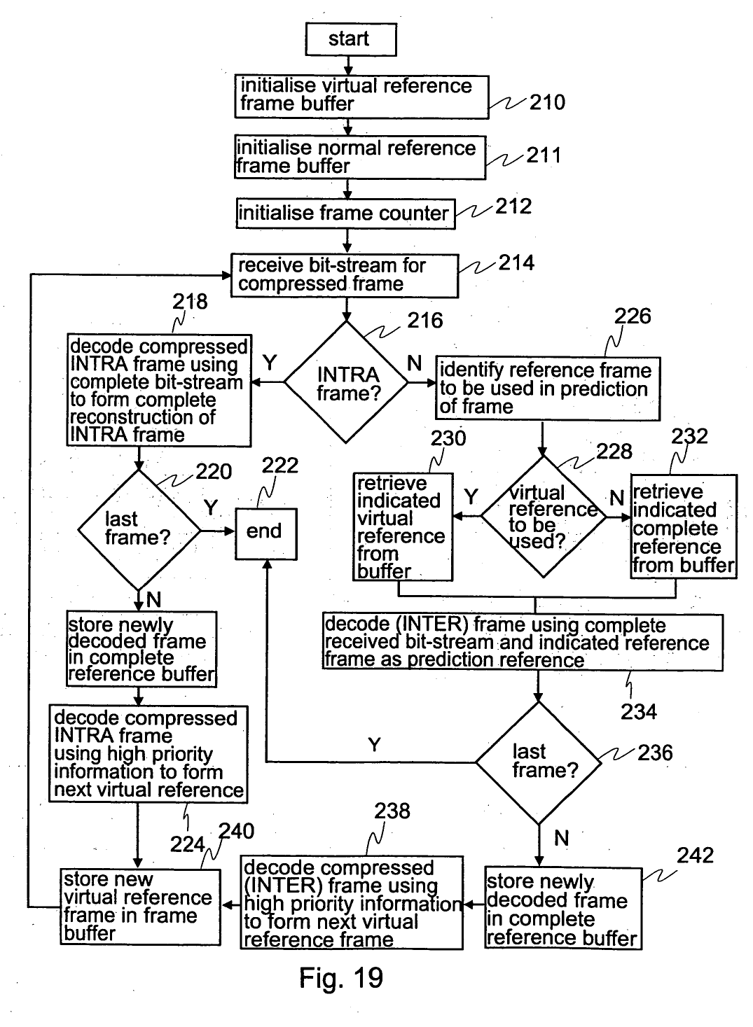

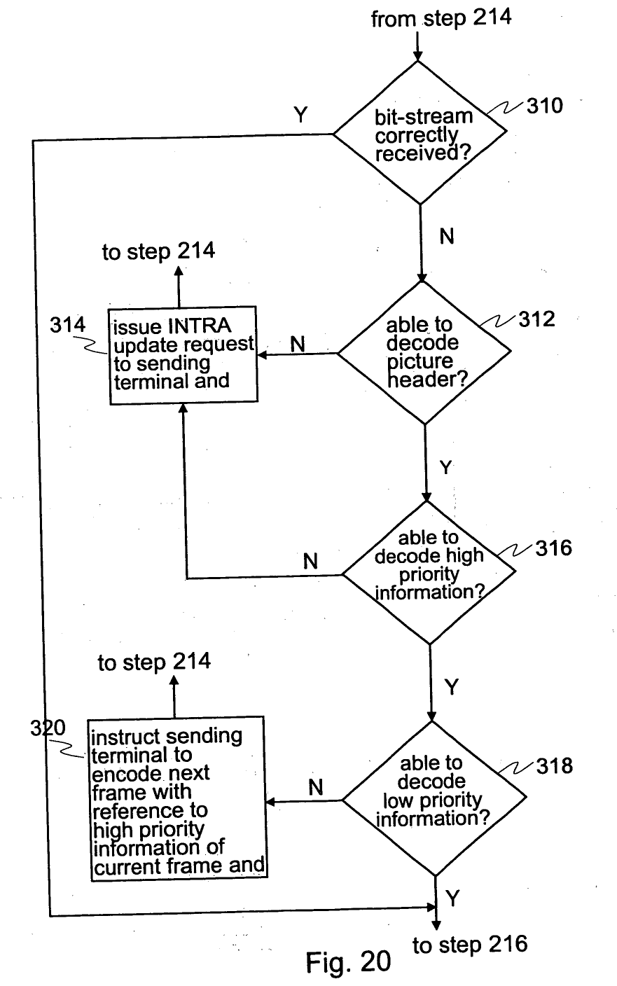

The invention will now be described in greater detail as a set of procedural steps with reference to FIG. 18, which illustrates an encoding procedure carried out by an encoder and to FIG. 19, which illustrates a decoding procedure carried out by a decoder corresponding to the encoder. The procedural steps presented in FIGS. 18 and 19 may be implemented in a video transmission system according to FIG. 16.

Reference will first be made to the encoding procedure illustrated by FIG. 18. In an initialization phase, the encoder initialises a frame counter (step 110), initialises a complete reference frame buffer (step 112) and initialises a virtual reference frame buffer (step 114). The encoder then receives raw, that is uncoded, video data from a source (step 116), such as a video camera. The video data may originate from a live feed. The encoder receives an indication of the coding mode to be used in the coding of a current frame. (step 118), that is, whether it is to be an INTRA frame or an INTER frame. The indication can come from a pre-set coding scheme (block 120). The indication can optionally come from a scene cut detector (block 122), if one is provided, or as feedback from a decoder (block 124). The encoder then makes a decision whether to code the current frame as an INTRA frame (step 126).

If the decision is “YES” (decision 128), the current frame is encoded to form a compressed frame in INTRA frame format (step 130).

If the decision is “NO” (decision 132), the encoder receives an indication of a frame to be used as a reference in encoding the current frame in INTER frame format (step 134). This can be determined as a result of a predetermined coding scheme (block 136). In another embodiment of the invention, this may be controlled by feedback from the decoder (block 138). This will be described later. The identified reference frame may be a complete frame or a virtual frame and so the encoder determines whether a virtual reference is to be used (step 140).

If a virtual reference frame is to be used, it is retrieved from the virtual reference frame buffer (step 142). If a virtual reference is not to be used, a complete reference frame is retrieved from the complete frame buffer (step 144). The current frame is then encoded in INTER frame format using the raw video data and the selected reference frame (step 146). This pre-supposes the presence of complete and virtual reference frames in their respective buffers. If the encoder is transmitting the first frame following initialisation, this is usually an INTRA frame and so no reference frame is used. Generally, no reference frame is required whenever a frame is encoded in INTRA format.

Irrespective of whether the current frame is encoded into INTRA frame format or INTER frame format, the following .steps are then applied. The encoded frame data is prioritised (step 148), the particular prioritisation depending on whether INTER frame or INTRA frame coding has been used. The prioritisation divides the data into low priority and high priority data on the basis of how essential it is to the reconstruction of the picture being encoded. Once so divided a bit-stream is formed for transmission. In forming the bit-stream a suitable packetisation method is used. Any suitable packetisation scheme may be used. The bit-stream is then transmitted to the decoder (step 152). If the current frame is the last frame, a decision is made (step 154) to terminate the procedure (block 156) at this point.

If the current frame is INTER coded and is not the last frame in the sequence, the encoded information representing the current frame is decoded on the basis of the relevant reference frame using both the low priority and high priority data in order to form a complete reconstruction of the frame (step 157). The complete reconstruction is then stored in the complete reference frame buffer (step 158). The encoded information representing the current frame is then decoded on the basis of the relevant reference frame using only the high priority data in order to form a reconstruction of a virtual frame (step 160). The reconstruction of the virtual frame is then stored in the virtual reference frame buffer (step 162). Alternatively, if the current frame is INTRA coded and is not the last frame in the sequence, appropriate decoding is performed at steps 157 and 160 without use of a reference frame. The set of procedural steps starts again from step 116 and the next frame is then encoded and formed into a bit-stream.

In an alternative embodiment of the invention the order of the steps presented above may be different. For example, the initialisation steps can occur in any convenient order, as can the steps of decoding the reconstruction of the complete reference frame and the reconstruction of the virtual reference frame.

Although the foregoing describes a frame being predicted from a single reference, in another embodiment of the invention, more than one reference frame can be used to predict a particular INTER coded frame. This applies both to complete INTER frames and to virtual INTER frames. In other words, in alternative embodiments of the invention a complete INTER coded frame may have multiple complete reference frames or multiple virtual reference frames. A virtual INTER frame may have multiple virtual reference frames. Moreover, the Selection of a reference frame or reference frames can be made separately/independently for each picture segment, macroblock, block or sub-element of a picture being encoded. A reference frame can be any complete or virtual frame that is accessible or can be generated both in the encoder and in the decoder. In some situations, such as in the case of B frames, two or more reference frames are associated with the same picture area, and an interpolation scheme is used to predict the area to be coded. Furthermore, each complete frame may be associated with a number of different virtual frames, constructed using different ways of classifying the encoded information of the complete frame; and/or different reference (virtual or complete) pictures for motion compensation; and/or different ways of decoding the high priority part of the bit-stream. In such embodiments, multiple complete and virtual reference frame buffers are provided in the encoder and decoder.

Reference will now be made to the decoding procedure illustrated by FIG. 19. In an initialisation phase the decoder initialises a virtual reference frame buffer (step 210), a normal reference frame buffer (step 211) and a frame counter (step 212). The decoder then receives a bit-stream relating to a compressed current frame (step 214). The decoder then determines whether the current frame is encoded in INTRA frame format or INTER frame format (step 216). This can be determined from information received, for example, in the picture header.

If the current frame is in INTRA frame format, it is decoded using the complete bit-stream to form a complete reconstruction of the INTRA frame (step 218). If the current frame is the last frame then a decision is made (step 220) to terminate the procedure (step 222). Assuming the current frame is not the last frame, the bit-stream representing the current frame is then decoded using high priority data in order to form a virtual frame (step 224). The newly constructed virtual frame is then stored in the virtual reference frame buffer (step 240), from where it can be retrieved for use in connection with the reconstruction of a subsequent complete and or virtual frame.

If the current frame is in INTER frame format, the reference frame used in its prediction at the encoder, is identified (step 226). The reference frame may be identified, for example, by data present in the bit-stream transmitted from encoder to decoder. The identified reference may be a complete frame or a virtual frame and so the decoder determines whether a virtual reference is to be used (step 228).

If a virtual reference is to be used, it is retrieved from the virtual reference frame buffer (step 230). Otherwise, a complete reference frame is retrieved from the complete reference frame buffer (step 232). This pre-supposes the presence of normal and virtual reference frames in their respective buffers. If the decoder is receiving the first frame following initialisation, this is usually an INTRA frames and so no reference frame is used. Generally, no reference frame is required whenever a frame is encoded in INTRA format is to be decoded.

The current (INTER) frame is then decoded and reconstructed using the complete received bit-stream and the identified reference frame as a prediction reference (step 234) and the newly decoded frame is stored in the complete reference frame buffer (step 242), from where it can be retrieved for use in connection with the reconstruction of a subsequent frame.

If the current frame is the last frame then a decision is made (step 236) to terminate the procedure (step 222). Assuming that the current frame is not the last frame, the bit-stream representing the current frame is then decoded using high priority data in order to form a virtual reference frame (step 238). This virtual reference frame is then stored in the virtual reference frame buffer (step 240), from where it can be retrieved for use in connection with the reconstruction of a subsequent complete and/or virtual frame.

It should be noted that decoding of the high priority information to construct a virtual frame does not necessarily follow the same decoding procedure as used when decoding the complete representation of the frame. For example, low priority information absent from the information representing the virtual frame may be replaced by default values in order enable decoding of the virtual frame.

As mentioned in the foregoing, in one embodiment of the invention, selection of a complete or a virtual frame for use as a reference frame in the encoder is carried out on the basis of feedback from the decoder.

FIG. 20 shows additional steps which modify the procedure of FIG. 19 to provide this feedback. The additional steps of FIG. 20 are inserted between steps 214 and 216 of FIG. 19. Since FIG. 19 has been fully described in the foregoing only the additional steps will be described here.

Once a bit-stream for a compressed current frame has been received (step 214), the decoder checks (step 310) whether the bit-stream has been correctly received. This involves general error checking followed by more specific checks depending on the severity of the error. If the bit-stream has been correctly received then the decoding process can proceed directly to step 216, where the decoder determines whether the current frame is encoded in INTRA frame format or in INTER frame format, as described in connection with FIG. 19.

If the bit-stream has not been correctly received the decoder next determines whether it is able to decode the picture header (step 312). If it cannot, it issues an INTRA frame up-date request to the sending terminal comprising the encoder (step 314) and the procedure returns-to step 214. Alternatively, instead of issuing an INTRA frame update request, the decoder could indicate that all of the data for the frame was lost, and the encoder could react to this indication so that it does not refer to the lost frame in motion compensation.

If the decoder can decode the picture header, it determines whether it is able to decode the high priority data (step 316). If it cannot, step 314 is performed and the procedure returns to step 214.

If the decoder can decode the high priority data, it determines whether it is able to decode the low priority data (step 318). If it cannot, it instructs the sending terminal containing the encoder to encode the next frame predicted with respect to the high priority data of the current frame and not the low priority data (step 320). The, procedure then returns to step 214. Thus, according to the invention, a new type of indication is provided as feedback to the encoder. According to the details of the particular implementation, the indication may provide information relating to the codewords of one or more specified pictures. The indication may indicate codewords which have been received, codewords which have not been received or may provide information about both codewords which have been received as well as those which have not been received. Alternatively, the indication may simply take the form of a bit or codeword indicating that an error has occurred in the low priority information for the current frame, without specifying the nature of the error or which codeword(s) were affected.

The indication just described provides the feedback referred to above in relation to block 138 of the encoding method. On receiving the indication from the decoder, the encoder knows that it should encode the next frame in the video sequence with respect to a virtual reference frame based on the current frame.

The procedure described above applies if there is a sufficiently low delay that the encoder can receive the feedback information before encoding the next frame. If this is not the case, it is preferred to send an indication that the low priority part of the particular frame was lost. The encoder then reacts to this indication in such a way that it does not use the low priority information in the next frame it is going to encode. In other words, the encoder generates a virtual frame whose prediction chain does not include the lost low priority part.

Decoding of a bit-stream for virtual frames may use a different algorithm from that used to decode the bit-stream for complete frames. In one embodiment of the invention, a plurality of such algorithms is provided, and the selection of the correct algorithm to decode a particular virtual frame is signalled in the bit-stream. In the absence of low priority information, it may be replaced by some default values in order to enable decoding of a virtual frame. The selection of the default values may vary, and the correct selection may be signalled, in the bit-stream, for example by using the indication referred to in the preceding paragraph.

The procedures of FIG. 18 and FIGS. 19 and 20 can be implemented in the form of a suitable computer program code and can be executed on a general purpose microprocessor or dedicated digital signal processor (DSP).

It should be noted that although the procedures of FIGS. 18, 19 and 20 use a frame-by-frame approach to encoding and decoding, in other embodiments of the invention substantially the same procedures can be applied to image segments. For example, the method may be applied to groups of blocks, to slices, to macroblocks or blocks. In general, the invention can be applied to any picture segment, not just groups of blocks, slices, macroblocks and blocks.

For the sake of simplicity, the encoding and decoding of B-frames using the method according to the invention was not described in the foregoing. However, it should be apparent to a person skilled in the art that the method can be extended to cover the encoding and decoding of B-frames. Furthermore, the method according to the invention may also be applied in systems that employ video redundancy coding. In other words, Sync frames can also be included in an embodiment of the invention. If virtual frames are used in the prediction of sync frames, there is no need for the decoder to generate a particular virtual frame if the primary representation (that is the corresponding complete frame) is correctly received. Neither is it necessary to form a virtual reference frame for other copies of the sync frame, for example when the number of threads used is greater than two.

In one embodiment of the invention, a video frame is encapsulated in at least two service data units (i.e. packets), one with high importance and the other one with low, importance. If H.26L is used, the low importance packet can contain coded block data and prediction error coefficients, for example.

In FIGS. 18, 19 and 20, reference is made to decoding a frame by using high priority information in order to form a virtual frame (see blocks 160, 224 and 238). In an embodiment of the invention this can actually be carried out in two stages, as follows:
1) In the first stage a temporary bit-stream representation of a frame is generated comprising the high priority information and default values for the low priority information and
2) in the second stage the temporary bit-stream representation is decoded normally, that is in a manner identical to the decoding performed when all information is available.

It should be appreciated that this approach represents just one embodiment of the invention, since the selection of default values can be tuned and the decoding algorithm for the virtual frame may not be the same as that used to decode complete frames.

It should be noted that there is no specific limit to the number of virtual frames which can be generated from each complete frame. Thus, the embodiment of the invention described in connection with FIGS. 18 and 19 represents just one possibility in which a single chain of virtual frames is generated. In a preferred embodiment of the invention, multiple chains of virtual frames are generated, each chain comprising virtual frames generated in a different manner, for example using different information from the complete frames.

It should further be noted that in a preferred embodiment of the invention, the bit-stream syntax is similar to the syntax used in single-layer coding in which enhancement layers are not provided. Moreover, since virtual frames are generally not displayed, a video encoder according to the invention can be implemented in such a way that it can decide how to generate a virtual reference frame when it starts to encode a subsequent frame with respect to the virtual reference frames in question. In other words, an encoder can use the bit-stream of previous frames flexibly and frames can be divided into different combinations of codewords even after they are transmitted. Information indicating which codewords belong to the high priority information for a particular frame can be transmitted when a virtual prediction frame is generated. In the prior art, a video encoder chooses the layering division of a frame while encoding the frame and the information is transmitted within the bit-stream of the corresponding frame.

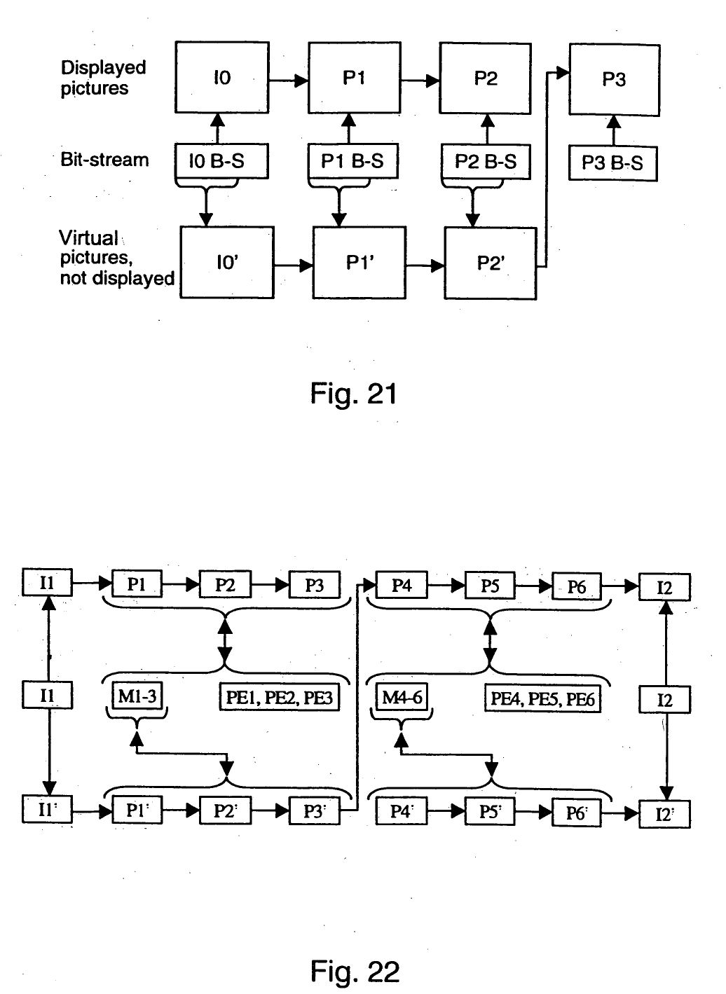

FIG. 21 illustrates in graphical form the decoding of a section of a video sequence including INTRA-coded frame 10 and INTER-coded frames P1, P2, and P3. This figure is provided to show the effect of the procedure described in relation to FIGS. 19 and 20 and, as can be seen, it comprises a top row, a middle row and a bottom row. The top row corresponds to reconstructed and displayed frames (that is, complete frames), the middle row corresponds to the bit-stream for each frame and the bottom row corresponds to virtual prediction reference frames which are generated. Arrows indicate the input sources used to produce reconstructed complete frames and virtual reference frames. Referring to the Figure, it can be seen that frame I0 is generated from a corresponding bit-stream I0 B-S and complete frame P1 is reconstructed using frame I0 as a motion compensation reference together with the received bit-stream for P1. Similarly, virtual frame I0′ is generated from a part of the bit-stream corresponding to frame I0 and artificial frame P1 is generated using I0′ as a reference for motion compensated prediction, together with a part of the bit-stream for P1. Complete frame P2 and virtual frame P2′ are generated in a similar fashion using motion compensated prediction from frames P1 and P1′, respectively. More, specifically, complete frame P2 is generated using P1 as a reference for motion compensated prediction, together with the information received bit-stream P1 B-S, while virtual frame P2′ is constructed using virtual frame P1′ as a reference frame, together with a part of the bit-stream P1 B-S. According to the invention, frame P3 is generated using virtual frame P2′ as a motion compensation reference and the bit-stream for P3. Frame P2 is not used as a motion compensation reference.

It is evident from FIG. 21 that a frame and its virtual counterpart are decoded using different parts of the available bit-stream. Complete frames are constructed using all of the available bit-stream, while the virtual frames only use part of the bit-stream. The part the virtual frames use is a part of the bit-stream which is most significant in decoding a frame. In addition, it is preferred that the part the virtual frames use is the most robustly protected against errors for transmission, and thus most likely to be successfully transmitted and received. In this way, the invention is able to shorten the predictive coding chain and base a predicted frame on an virtual motion compensation reference frame which is generated from the most significant part of a bit-stream rather than on a motion compensation reference which is generated by using the most significant part and a less significant part.

There are circumstances in which separating the data into high and low priority is not necessary. For example, if the whole data relating to a picture can fit into a single packet, then it may be preferred not to separate the data. In this case, the whole data may be used in prediction from a virtual frame. Referring to FIG. 21, in this particular embodiment, frame P1′ is constructed by predicting from virtual frame I0′ and by decoding all of the bit-stream information for P1. The reconstructed virtual frame P1′ is not equivalent to frame P1, because the prediction reference for frame P1 is I0 whereas the prediction reference for frame P1′ is I0′. Thus, P1′ is a virtual frame, even though, in this case, it is predicted from a frame (P1) having information which is not prioritised into high and low priority.

An embodiment of the invention will now be described with reference to FIG. 22. In this embodiment, motion and header data is separated from prediction error data in the bit-stream generated from the video sequence. The motion and header data is encapsulated in a transmission packet called a motion packet and the prediction error data is encapsulated in a transmission packet called a prediction error packet. This is done for several consecutive coded pictures. Motion packets have high priority and they are re-transmitted whenever it is possible and necessary, since error concealment is better if the decoder receives motion information correctly. The use of motion packets, also has the effect of improving compression efficiency. In the example presented in FIG. 22, the encoder separates motion and header data, from P-frames 1 to 3 and forms a motion packet (M1-3) from that information. Prediction error data for P-frame 1 to 3 is transmitted in a separate prediction error packet (PE1, PE2, PE3). In addition to using I1 as a motion compensation reference, the encoder generates virtual frames P1′, P2′ and P3′ based on I1 and M1-3. In other words, the encoder decodes I1 and the motion part of prediction frames P1, P2, and P3 so that P2′ is predicted from P1′ and P3′ is predicted from P2′. Frame P3′ is then used as a motion, compensation reference for frame P4. In this embodiment virtual frames P1′, P2′ and P3′ are referred to as a Zero-Prediction-Error (ZPE) frames since they do not contain any prediction error data.

When the procedures of FIG. 18, 19 and 20 are applied to H.26L, pictures are encoded in such a way that they comprise picture headers. The information included in the picture header is the highest priority information in the classification scheme described earlier because without the picture header, the entire picture cannot be decoded. Each picture header contains a picture type (Ptype) field. According to the invention, a particular value is included to indicate whether the picture uses one or more virtual reference frames. If the value of the Ptype field indicates that one or more virtual reference frame is to be used, the picture header is also provided with information on how to generate the reference frame(s). In other embodiments of the invention, this information may be included in slice headers, macroblock headers and/or block headers, depending on the kind of packetisation used. Furthermore, if multiple reference frames are used in connection with the encoding of a given frame, one or more of the reference frames may be virtual. The following signalling schemes are used:
1. An indication of which frame(s) of the past bit-stream is/are used to generate a reference frame is provided in the transmitted bit-stream. Two values are transmitted: one that corresponds to the temporally last picture used for prediction and another one that corresponds to the temporally earliest picture used for prediction. It will be apparent to a person of ordinary skill in the art that the encoding and decoding procedures illustrated in FIGS. 18 and 19 can be suitably modified to make use of this indication.
2. An indication of which coding parameters are used to generate a virtual frame. The bit-stream is adapted to carry, an indication of the lowest priority class that is used for prediction. For example, if the bit-stream carries an indication corresponding to class 4, the virtual frame is formed from parameters belonging to classes 1, 2, 3, and 4. In an alternative embodiment of the invention a more general scheme is used in which each of the classes used to construct a virtual frame is signalled individually.

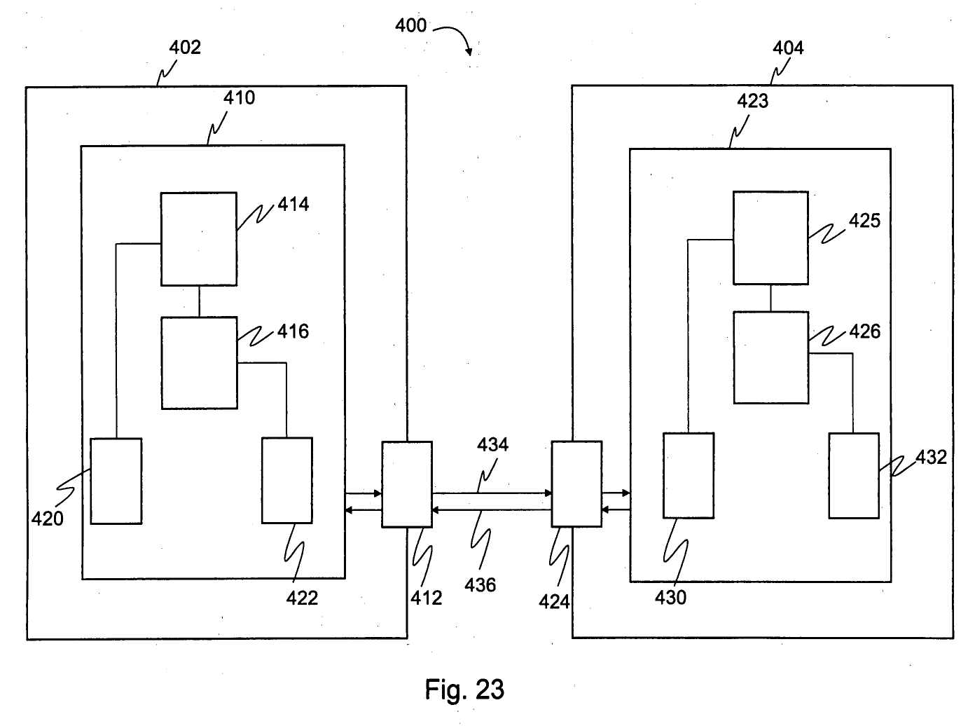

FIG. 23 shows a video transmission system 400 according to the invention. The system comprises communicating video terminals 402 and 404. In this embodiment, terminal-to-terminal communication is shown. In another embodiment, the system may be configured for terminal-to-server or server-to-terminal communication. Although it is intended that the system 400 enables bi-directional transmission of video data in the form of a bit-stream, it may enable only unidirectional transmission of video data. For the sake of simplicity, in the system 400 shown in FIG. 23, the video terminal 402 is a transmitting (encoding) video terminal and the video terminal 404 is a receiving (decoding) video terminal.

The transmitting video terminal 402 comprises an encoder 410 and a transceiver 412. The encoder 410 comprises a complete frame encoder 414, a virtual frame constructor 416, as well as a multi-frame buffer 420 for storing complete frames and a multi-frame buffer 422 for storing virtual frames.

The complete frame encoder 414 forms a an encoded representation of a complete frame, containing information for its subsequent full reconstruction. Thus, complete frame encoder 414 carries out steps 118 to 146 and step 150 of FIG. 18. Specifically, complete frame encoder 414 is capable of encoding complete frames in either INTRA format (e.g. according to steps 128 and 130 of FIG. 18) or in INTER format. The decision to encode a frame in a particular format (INTRA or INTER) is made according to information provided to the encoder at steps 120, 122 and/or 124 of FIG. 18. In the case of complete frames encoded in INTER format, the complete frame encoder 414 can use either a complete frame as a reference for motion compensated prediction (according to steps 144 and 146 of FIG. 18) or a virtual reference frame (according to steps 142 and 146 of FIG. 18). In an embodiment of the invention, complete frame encoder 414 is adapted to select a complete or virtual reference frame for motion compensated prediction according to a predetermined scheme (according to step 136 of FIG. 18). In an alternative and preferred embodiment, the complete frame encoder 414 is further adapted to receive an indication as feedback from a receiving encoder specifying that a virtual reference frame should be used in the encoding of a subsequent complete frame (according to step 138 of FIG. 18). The complete frame encoder also comprises local decoding functionality and forms a reconstructed version of the complete frame according to step 157 of FIG. 18, which it stores in multi-frame buffer 420 according to step 158 of FIG. 18. The decoded complete frame thus becomes available for use a reference frame for motion compensated prediction of a subsequent frame in, the video sequence.

The virtual frame constructor 416 defines a virtual frame as a version of the complete frame, constructed using the high, priority information of the complete frame in the absence of at least some of the low priority information of the complete frame according to steps 160 and 162 of FIG. 18. More specifically, the virtual frame constructor forms a virtual frame by decoding the frame encoded by the complete frame encoder 414 using the high priority information of the complete frame in the absence of at least some of the low priority information. It then stores the virtual frame in multi-frame buffer 422. The virtual frame thus becomes available for use as a reference frame formation compensated prediction of a subsequent frame in the video sequence.

According to one embodiment of encoder 410, the information of the complete frame is prioritised according to step 148 of FIG. 18 in the complete frame encoder 414. According to an alternative embodiment, prioritisation according to step 148 of FIG. 18 is performed by the virtual frame constructor 416. In embodiments of the invention in which information concerning the prioritisation of encoded information for the frame is transmitted to the decoder, prioritisation of the information for each frame can take place in either the complete frame encoder or the virtual frame constructor 416. In implementations in which prioritisation of the encoded information for frames is performed by the complete frame encoder 414, the complete frame, encoder 414 is also responsible for forming the prioritisation information for subsequent transmission to the decoder 404. Similarly, in embodiments in which prioritisation of the encoded information for frames is performed by the virtual frame constructor 416, the, virtual frame constructor 416 is also responsible for forming the prioritisation information for transmission to the decoder 404.

The receiving video terminal 404 comprises a decoder 423 and a transceiver 424. The decoder 423 comprises a complete frame decoder 425, a virtual frame decoder 426, as well as a multi-frame buffer 430 for storing complete frames and a multi-frame buffer 432 for storing virtual frames.

The complete frame decoder 425 decodes a complete frame from a bit-stream containing information for the full reconstruction of the complete frame. The complete frame may be encoded in either INTRA or INTER format. Thus, the complete frame decoder carries out steps 216, 218 and step 226 to 234 of FIG. 19. The complete frame decoder stores the newly reconstructed complete frame in multi-frame buffer 430 for future use as a motion compensated prediction reference frame, according to step 242 of FIG. 19.

The virtual frame decoder 426 forms a virtual frame from the bit-stream of the complete frame using the high priority information of the complete frame in the absence of at least some of the low priority information of the complete frame according to steps 224 or 238 of FIG. 19 depending on whether the frame was encoded in INTRA or INTER format. The virtual frame decoder further stores the newly decoded virtual frame in multi-frame buffer 432 for future use as a motion compensated prediction reference frame, according to, step 240 of FIG. 19.

According to an embodiment of the invention, the information of the bit-stream, is prioritised in the virtual frame decoder 426 according to a scheme identical to that used in the encoder 410 of the transmitting terminal 402. In an alternative embodiment, the receiving terminal 404 receives an indication of the prioritisation scheme used in the encoder 410 to prioritise the information of the complete frame. The information provided by this indication is then used by the virtual frame decoder 426 to determine the prioritisation used in the encoder 410 and to subsequently form the virtual frame.

The video terminal 402 produces an encoded video bit-stream 434 which is transmitted by the transceiver 412 and received by the transceiver 424 across a suitable transmission medium. In one embodiment of the invention, the transmission medium is an air interface in a wireless communications system. The transceiver 424 transmits feedback 436 to the transceiver 412. The nature of this feedback has been described in the foregoing.

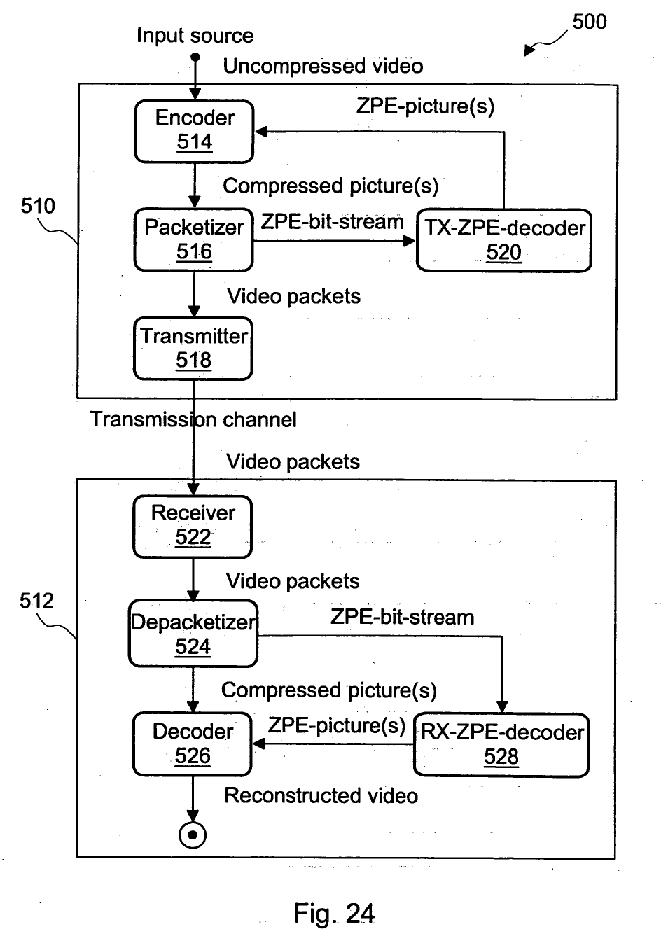

Operation of a video transmission system 500 utilising ZPE frames will now be described. The system 500 is shown in FIG. 24. The system 500 has a transmitting terminal 510 and a plurality of receiving terminals 512 (only one of which is shown) which communicate over a transmission channel or network. The transmitting terminal 510 comprises an encoder 514, a packetiser 516 and a transmitter 518. It also comprises a TX-ZPE-decoder 520. The receiving terminals 512 each comprise a receiver 522 a de-packetiser 524 and a decoder 526. They also each comprise a RX-ZPE-decoder 528. The encoder 514 codes uncompressed video to form compressed video pictures. The packetiser 516 encapsulates compressed video pictures into transmission packets. It may reorganise the information obtained from the encoder. It also outputs video pictures that contain no prediction error data for motion compensation (called the ZPE-bit-stream). The TX-ZPE-decoder 520 is a normal video decoder that is used to decode the ZPE-bit-stream. The transmitter 518 delivers packets over the transmission channel or network. The receiver 522 receives packets from the transmission channel or network. The de-packetiser 524 de-packetises the transmission packets and generates compressed video pictures. If some packets are lost during transmission, the de-packetiser 524 tries to conceal the losses in the compressed video pictures. In addition, the de-packetiser 524 outputs the ZPE-bit-stream. The decoder 526 reconstructs pictures from the compressed video bit-stream. The RX-ZPE-decoder 528 is a normal video decoder that is used to decode a ZPE-bit-stream.

The encoder 514 operates normally except for the case when the packetiser 516 requests a ZPE frame to be used as a prediction reference. Then the encoder 514 changes the default motion compensation reference picture to the ZPE frame that is delivered by the TX-ZPE-decoder 520. Moreover, the encoder 514 signals the usage of the ZPE frame in the compressed bit-stream, for example in the picture type of the picture.

The decoder 526 operates normally except for the case when the bit-stream contains a ZPE frame signal. Then the decoder 526 changes the default motion compensation reference picture to the ZPE frame that is delivered by the RX-ZPE-decoder 528.

Performance of the invention is presented compared against reference picture selection as specified in the current H.26L recommendation. Three commonly available test sequences are compared, namely Akiyo, Coastguard, and Foreman. The resolution of the sequences is QCIF, having a luminance picture size of 176×144 pixels and a chrominance picture size of 88×72 pixels. Akiyo and Coastguard are captured with 30 frames per second, whereas the frame rate of Foreman is 25 frames per second. The frames were coded with an encoder following ITU-T recommendation H.263. In order to compare different methods, a constant target frame rate (of 10 frames per second) and a number of constant image quantisation parameters were used. The thread length, L, was, selected so that the size of the motion packet was less than 1400 bytes (that is, that the motion data for a thread was less than 1400 bytes).

The ZPE-RPS case has frames I1, M1-L, PE1, PE2, . . . , PEL, P(L+1) (predicted from ZPE1-L), P(L+2), . . . , whereas the normal RPS case has frames I1, P1, P2, . . . , PL, P(L+1) (predicted from I1), P(L+2). The only frame coded differently in the two sequences was P(L+1), but the image quality of this frame in both sequences is similar due to use of a constant quantisation step. The table below shows the results:

| | | | | Bit rate | Bit rate | Bit rate | Bit rate |
|---|---|---|---|---|---|---|---|
| | | Number of | Original | increase, | increase, | increase, | increase, |
| | | coded frames | bit rate | ZPE-RPS | ZPE-RPS | normal RPS | normal RPS |
| | QP | in thread, L | (bps) | (bps) | (%) | (bps) | (%) |
| Akiyo | 8 | 50 | 17602 | 14 | 0.1% | 158 | 0.9% |
| | 10 | 53 | 12950 | 67 | 0.5% | 262 | 2.0% |
| | 13 | 55 | 9410 | 42 | 0.4% | 222 | 2.4% |
| | 15 | 59 | 7674 | −2 | 0.0% | 386 | 5.0% |
| | 18 | 62 | 6083 | 24 | 0.4% | 146 | 2.4% |
| | 20 | 65 | 5306 | 7 | 0.1% | 111 | 2.1% |
| Coastguard | 8 | 16 | 107976 | 266 | 0.2% | 1505 | 1.4% |
| | 10 | 15 | 78458 | 182 | 0.2% | 989 | 1.3% |
| | 15 | 15 | 43854 | 154 | 0.4% | 556 | 1.3% |
| | 18 | 15 | 33021 | 187 | 0.6% | 597 | 1.8% |
| | 20 | 15 | 28370 | 248 | 0.9% | 682 | 2.4% |
| Foreman | 8 | 12 | 87741 | 173 | 0.2% | 534 | 0.6% |
| | 10 | 12 | 65309 | 346 | 0.5% | 622 | 1.0% |
| | 15 | 11 | 39711 | 95 | 0.2% | 266 | 0.7% |
| | 18 | 11 | 31718 | 179 | 0.6% | 234 | 0.7% |
| | 20 | 11 | 28562 | −12 | 0.0% | −7 | 0.0% |

It can be seen from the bit-rate increase columns of the results that Zero-Prediction-Error frames improved the compression efficiency when Reference Picture Selection is used.

Particular implementations and embodiments of the invention have been described. It is clear to a person skilled in the art that the invention is not restricted to details of the embodiments presented above, but that it can be implemented in other embodiments using equivalent means without deviating from the characteristics of the invention. The scope of the invention is only restricted by the attached patent claims.

1-27. (canceled)

28. A method for decoding of encoded video frames, the encoded video frames being described by syntax elements, the syntax elements having decoding dependencies in accordance with a dependency tree having a root, the method comprising:
receiving an encoded video frame described by syntax elements in accordance with said dependency tree,
forming a first reference frame using all of the syntax elements of said dependency tree, and
forming a second reference frame using some of the syntax elements of said dependency tree, wherein used syntax elements comprise the tree root and unused syntax elements are on branches away from the root.

29. A method for decoding of encoded video frames according to claim 28, further comprising replacing the unused syntax elements with default values when forming the second reference frame.

30. A method for decoding of encoded video frames according to claim 29, further comprising selecting the default values based upon an indication signaled in a bitstream.

31. A method for decoding of encoded video frames according to claim 29, further comprising:
generating a temporary bit-stream comprising the used syntax elements and the default values, and
decoding the temporary bit-stream in a manner identical to the decoding performed when all of the syntax elements are used.

32. A method for decoding of encoded video frames according to claim 28, wherein forming the second reference frame is done using a selected algorithm, the selected algorithm being selected based upon an indication signaled in a bitstream.

33. A method for decoding according to claim 28, further comprising decoding a second encoded video frame using prediction from the first reference frame.

34. A method for decoding according to claim 28, further comprising decoding a second encoded video frame using prediction from the second reference frame.

35. A method of decoding according to claim 34, wherein the decoding using prediction from the second reference frame is in response to an indication that is part of the second encoded video frame.

36. A method for decoding of encoded video frames, the encoded video frames being described by syntax elements, the syntax elements having decoding dependencies in accordance with a dependency tree having a root, the method comprising:
receiving an encoded video frame described by syntax elements in accordance with said dependency tree,
determining an inability to form a first reference frame using all of the syntax elements of said dependency tree, the inability resulting from syntax element errors,
forming a second reference frame using some of the syntax elements of said dependency tree, wherein used syntax elements comprise the tree root and unused syntax elements are on branches away from the root, and
sending an indication to an encoder, the indication being instructive of the inability to form the first reference frame.

37. A method for encoding of video frames to produce encoded video frames, the encoded video frames comprising syntax elements, the syntax elements having decoding dependencies in accordance with a dependency tree having a root, the method comprising:
receiving a first video frame,
using a first reference frame to encode the first video frame to produce a first encoded frame, the first encoded frame comprising syntax elements in accordance with said dependency tree,
decoding the first encoded frame using all of the syntax elements of said dependency tree,
storing a result of the decoding of the first encoded frame in a first buffer,
receiving a second video frame,
using a second reference frame to encode the second video frame to produce a second encoded frame, the second encoded frame comprising syntax elements in accordance with said dependency tree,
decoding the second encoded frame using some of the syntax elements of said dependency tree, wherein used syntax elements comprise the tree root and unused syntax elements are on branches away from the root, and
storing the result of the decoding of the second encoded frame in a second buffer.

38. A method according to claim 37, comprising:
receiving a third video frame, and
using said result of the decoding of the second encoded frame stored in said second buffer as a reference to encode the third video frame to produce a third encoded frame.

39. A method according to claim 37, comprising:
receiving a third video frame, and
using said result of the decoding of the first encoded frame stored in said first buffer as a reference to encode the third video frame to produce a third encoded frame.

40. A method according to claim 37, further comprising specifying, in the first encoded frame, those syntax elements which are sufficient to produce an acceptable reconstructed picture.

41. A method according to claim 37, further comprising:
transmitting the first encoded frame,
choosing which of the syntax elements to use in forming the second reference frame, and
forming the second reference frame based upon the chosen syntax elements.

42. The method of claim 41, wherein transmitting the first encoded frame precedes in time choosing which syntax elements to use in forming the second reference frame.

43. A method according to claim 37, further comprising:
providing in the first encoded frame an indication of the first reference frame used for encoding, and
transmitting the first encoded frame.

44. A device for video decoding of encoded video frames, the encoded video frames being described by syntax elements, the syntax elements having decoding dependencies in accordance with a dependency tree having a root, the device comprising:
an input for receiving an encoded video frame,
a first frame decoder coupled to the input, the first frame decoder arranged to decode the encoded video frame using all of the syntax elements of said dependency tree to produce a first reference frame,
a first buffer coupled to the first frame decoder, the first buffer being arranged to store the first reference frame,
a second frame decoder coupled to the second frame decoder, the second frame decoder arranged to decode the encoded video frame using some of the syntax elements of said dependency tree to produce a second reference frame, wherein used syntax elements comprise the tree root and unused syntax elements are on branches away from the root, and
a second buffer coupled to the second frame decoder, the second buffer being arranged to store the second reference frame.

45. A device according to claim 441, wherein the device is arranged to decode a second encoded video frame using prediction from the first reference frame.

46. A device according to claim 44, wherein the device is arranged to decode a second encoded video frame using prediction from the second reference frame.

47. A device for video decoding according to claim 44, wherein the unused syntax elements comprise prediction error information.

48. A device for video decoding according to claim 47, wherein the used syntax elements comprise motion vector information.

49. A device for video decoding according to claim 44, wherein the second frame decoder is arranged to replace the unused syntax elements with default values before decoding.

50. A device for video encoding of video frames, the resulting encoded video frames being described by syntax elements, the syntax elements having decoding dependencies in accordance with a dependency tree having a root, the device comprising:
a frame encoder, the frame encoder arranged to encode a video frame to produce an encoded frame, the encoded frame being in accordance with said dependency tree, the frame encoder comprising decoding functionality, the decoding functionality arranged to produce a first reference frame, the first reference frame being produced by using all of the syntax elements of said dependency tree,
a first buffer coupled to the first frame decoder, the first buffer being arranged to store the first reference frame,
a frame constructor coupled to the frame encoder, the frame constructor arranged to decode the encoded video frame using some of the syntax elements of said dependency tree to produce a second reference frame, wherein used syntax elements comprise the tree root and unused syntax elements are on branches away from the root, and
a second buffer coupled to the frame constructor, the second buffer being arranged to store the second reference frame.

51. A device according to claim 50, wherein the device is arranged to encode a second video frame using prediction from the first reference frame.

52. A device according to claim 50, wherein the device is arranged to encode a second video frame using prediction from the second reference frame.

53. A device for video encoding of video frames according to claim 50, wherein the frame constructor is arranged to decide which syntax elements to use in constructing the second reference frame, wherein transmission of the encoded frame precedes in time, deciding which syntax elements to use.

54. A device for video encoding of video frames according to claim 50, wherein the frame encoder is arranged to specify, in the encoded frame, which syntax elements are sufficient to produce an acceptable reconstructed picture.

55. A video communications terminal comprising:
a decoder for decoding encoded video frames, the encoded video frames being described by syntax elements, the syntax elements having decoding dependencies in accordance with a dependency tree having a root, the decoder comprising an input for receiving an encoded video frame, a first frame decoder coupled to the input, the first frame decoder arranged to decode the encoded video frame using all of the syntax elements of said dependency tree to produce a first reference frame, the decoder further comprising a first buffer coupled to the first frame decoder, a second frame decoder coupled to the second frame decoder, the second frame decoder arranged to decode the encoded video frame using some of the syntax elements of said dependency tree, wherein used syntax elements comprise the tree root and unused syntax elements are on branches away from the root, and a second buffer coupled to the second frame decoder, and a transceiver coupled to the decoder.

56. A video communications terminal comprising:
an encoder for video encoding of video frames, the resulting encoded video frames being described by syntax elements, the syntax elements having decoding dependencies in accordance with a dependency tree having a root, the encoder comprising a frame encoder, the frame encoder arranged to encode a video frame to produce an encoded frame, the encoded frame being in accordance with said dependency tree, the frame encoder comprising decoding functionality, the decoding functionality arranged to produce a first reference frame, the first reference frame being produced by using all of the syntax elements of said dependency tree, the encoder further comprising a first buffer coupled to the first frame decoder, the first buffer being arranged to store the first reference frame, a frame constructor coupled to the frame encoder, the frame constructor arranged to decode the encoded video frame using some of the syntax elements of said dependency tree to produce a second reference frame, wherein used syntax elements comprising the tree root and unused syntax elements are on branches away from the root, and a second buffer coupled to the frame constructor, the second buffer being arranged to store the second reference frame, and
a transceiver coupled to the encoder.

57. A bit-stream representative of an encoded video frame, the encoded video frame comprising syntax elements, the syntax elements having decoding dependencies in accordance with a dependency tree having a root, the bit-stream comprising an indication for use by a decoder in determining which syntax elements have been used to form a reference frame by the encoder, wherein said reference frame has been formed using some of the syntax elements of said dependency tree, the used syntax elements comprising the tree root and the unused syntax elements being on branches away from the root, wherein said reference frame was used in the encoding process which produced the encoded video frame.
